(19) United States
(12) Patent Application Publication
(10) Pub. No.: US 2026/0253357 A1
(43) Pub. Date: Aug. 27, 2026

(54) THREE-DIMENSIONAL SPATIAL EXPERIENCE DESIGN

(71) Applicant: The Trustees of Indiana University, Bloomington, IN (US)

(72) Inventor: Zebulun Maxwell Wood, Westfield, IN (US)

(21) Appl. No.: 19/548,859

(22) Filed: Feb. 24, 2026

Related U.S. Application Data
(60) Provisional application No. 63/764,168, filed on Feb. 27, 2025.

(51) Int. Cl. G06T 19/20; G02B 27/01; H04N 13/344; H04N 13/351

(52) U.S. Cl. CPC G06T 19/20; G02B 27/017; H04N 13/344; H04N 13/351; G06T 2219/2004; G06T 2219/2016

(57) ABSTRACT

A system for collaborative three-dimensional (3D) experience design, includes a multiuser cloud-based spatial design platform configured to enable logins of first and second computing devices and to display first and second views of a spatial environment of a 3D experience including at least one visual element of the 3D experience to respective first and second displays of the first and second computing devices contemporaneously. The first and second displays are enabled to simultaneously or switchably display the first and second views of the spatial environment. Each of the first and second computing devices are enabled to modify at least one property of the at least one visual element of the 3D experience based on a visual element property modification recommendation derived from an inference of a machine learning (ML) model trained using 3D experience visual element property data. Visual element properties can also be automatically modified based on other criteria.

### CROSS-REFERENCE TO RELATED APPLICATIONS

The present application claims the benefit of U.S. Provisional Patent Application No. 63/764,168, filed Feb. 27, 2025, the disclosure of which is incorporated herein by reference.

### TECHNICAL FIELD

This description relates generally to aided design of software interfaces, and more particularly to systems, software tools, methods, and computer-readable media for aiding three-dimensional spatial experience design.

### BACKGROUND

Users can communicate with computer systems to perform functions using graphical user interfaces, which can be two-dimensional (2D) or, in the context of 3D experiences, three-dimensional (3D). 3D experiences include virtual reality (VR) experiences, augmented reality (AR) experiences, mixed reality (MR) experiences, and extended reality (XR) experiences. 3D interfaces can be implemented using a combination of software and hardware. As examples, the software aspects of 3D user interfaces (UIs), which render interface controls and display information based on computer instructions, can be perceived and interacted with using 3D hardware. The 3D hardware can include 3D displays, such as stereoscopic displays, including head-mounted displays (HMDs), which can display graphical information indicative of system state. The 3D hardware can further include interaction systems for 3D input, such as gesture interface systems that can track the positions of hands and/or fingers to determine the meanings of manual positions or gestures used to manipulate the 3D interface. Audio inputs, such as verbally issued commands or queries, can also serve as inputs to 3D interfaces.

Professionals that design computer experiences, such as 3D experiences, are herein referred to as designers, and professionals that make the designed experiences work operationally on hardware platforms, as by writing or adapting computer code by which the experiences are implemented via the hardware platforms, are herein referred to as developers. A “3D experience,” as that term is used herein, is a user-interactive experience that is three-dimensionally navigable for the user and for which sensed input actions of a user affect elements of an at least partially virtual rendered 3D environment. The terms “3D experience” and “spatial experience” are used interchangeably and should be regarded as synonymous for the purposes of this description.

### SUMMARY

An example system for collaborative 3D experience design includes a multiuser cloud-based spatial design platform. The spatial design platform is configured to enable logins of first and second computing devices and to display first and second views of a spatial environment of a 3D experience including at least one visual element of the 3D experience to respective first and second displays of the first and second computing devices contemporaneously. The spatial design platform is configured to enable the first display displaying the first view to simultaneously or switchably display the second view of the spatial environment. The spatial design platform is configured to enable the second display displaying the second view to simultaneously or switchably display the first view of the spatial environment. The system further includes a machine learning (ML) model trained using 3D experience visual element property data. The spatial design platform is configured to enable each of the first and second computing devices to modify at least one property of the at least one visual element of the 3D experience based on a visual element property modification recommendation derived from an inference of the ML model.

An example system for 3D experience design includes a spatial design platform configured to display a first view of a spatial environment of a 3D experience including at least one visual element of the 3D experience to a display. The spatial design platform is further configured to automatically modify at least one property of the at least one visual element of the 3D experience from a first property state to a second property state different from the first property state based on a proximity value indicative of a distance between the at least one visual element and a second element of the 3D experience, wherein the first view replicates or simulates display of the spatial environment with the at least one property of the at least one visual element in the first property state. The spatial design platform is further configured to enable the display displaying the first view to simultaneously or switchably display a second view of the spatial environment, wherein the second view replicates or simulates display of the spatial environment with the at least one property of the at least one visual element in the second property state.

Another example system for 3D experience design includes a spatial design platform that is configured to display a first view of a spatial environment of a 3D experience including at least one visual element of the 3D experience to a display. The first view replicates or simulates display of the spatial environment by first display hardware or a first display technology. The spatial design platform is further configured to enable the display displaying the first view to simultaneously or switchably display a second view of the spatial environment, wherein the second view replicates or simulates display of the spatial environment by second display hardware different from the first display hardware or a second display technology different from the first display technology. At least one property of the at least one visual element of the 3D experience is automatically modified in the second view based on a display setting or display hardware specification of the second display hardware or second display technology.

Another example system for 3D experience design includes an ML model trained using 3D experience visual element property data and a spatial design platform. The spatial design platform is configured to display a first view of a spatial environment of a 3D experience including at least one visual element of the 3D experience to a display. The first view replicates or simulates display of the spatial environment by first display hardware or a first display technology. The spatial design platform is further configured to enable the display displaying the first view to simultaneously or switchably display a second view of the spatial environment. The second view replicates or simulates display of the spatial environment by second display hardware different from the first display hardware or a second display technology different from the first display technology. At least one property of the at least one visual element of the 3D experience is automatically modified in the second view based on a visual element property modification recommendation derived from an inference of the ML model.

Another example system for 3D experience design includes a spatial design platform that is configured to display a first view of a spatial environment of a 3D experience, including at least one visual element of the 3D experience, to a display. The spatial design platform is further configured to enable modification of at least one property of the at least one visual element of the 3D experience from a first property state to a second property state different from the first property state. The first view replicates or simulates display of the spatial environment with the at least one property of the at least one visual element in the first property state. The spatial design platform is configured to enable the display displaying the first view to simultaneously or switchably display a second view of the spatial environment. The second view replicates or simulates display of the spatial environment with the at least one property of the at least one visual element in the second property state.

Aspects of the invention include methods that comprise performance of the above operations by the example systems for 3D experience design.

Additional aspects of the invention include computer-readable media comprising instructions that, when executed, cause the example systems for 3D experience design to perform the operations described above.

### BRIEF DESCRIPTION OF THE DRAWINGS

FIG. 1 is a system diagram of an example 3D display system such as may be used by an end user to perceive and interact with a 3D experience or as may be used by a designer as a 3D spatial design system to design a 3D experience or UI thereof.

FIG. 2 is a block diagram of an example system for collaborative 3D experience design.

FIG. 3 is a flow diagram of an example method of spatial design.

FIGS. 4A through 4C are diagrams illustrating translations of elements in X, Y, and Z axes, respectively, of a virtual 3D space.

FIG. 5 is a diagram illustrating example translation of an element elements in X, Y, and Z axes of a virtual 3D space.

FIGS. 6A and 6B are diagrams illustrating example latitude, longitude, and altitude measurements.

FIG. 7 is a diagram illustrating an example change of an element property in a time dimension.

FIG. 8 is a diagram illustrating an example change of element property of element size as dynamically responsive to a field of view and/or a resolution of a display.

FIG. 9 is a diagram illustrating an example change of an element property of transparency or visibility as dynamically responsive to display settings.

FIG. 10 is a diagram illustrating an example change of an element property of element size as dynamically responsive to display hardware specifications.

FIG. 11 is a diagram illustrating an example change of an element property of element size as dynamically responsive to user-element proximity based on a design rule or artificial intelligence (AI) recommendation.

FIG. 12 is a diagram illustrating an example of automatic positioning of a visual element along a first spatial dimension so that it is regularly distributed among two other visual elements.

FIG. 13 is a diagram illustrating an example of automatic positioning of a visual element in a second spatial dimension so that it is aligned with two other visual elements.

FIG. 14 is a diagram illustrating an example of automatic alignment of a visual element along a third spatial dimension so that it is aligned with two other visual elements.

FIG. 15 is a diagram illustrating an example of a 3D experience visual element having an AI-suggested color saturation property modification provided to a designer during a design phase of the element.

FIGS. 16, 17, and 18 are diagrams illustrating examples of a 3D experience visual element having an AI-suggested font property modification provided to a designer during a design phase of the element.

FIG. 19 is a diagram illustrating an example of 3D experience visual elements having an AI-suggested spacing and spatial arrangement property modifications provided to a designer during a design phase of the elements.

FIG. 20 is a diagram illustrating an example of a 3D experience visual element having an AI-suggested user-element distance property modification provided to a designer during a design phase of the element.

FIG. 21 is a diagram illustrating an example of an interaction template generated using an AI-based interaction recommendation.

FIG. 22 is a diagram illustrating an example of a multiuser interaction template generated using an AI-based interaction recommendation.

FIG. 23 is a diagram illustrating an example gesture- or gaze-based interaction having wide accessibility generated based on AI-based interaction recommendations.

FIG. 24 is a diagram illustrating an example of AI-based design collaboration

FIG. 25 is a diagram illustrating an example of AI-based development collaboration.

FIG. 26 is a diagram illustrating an example of recording of gesture-based, gaze-based, and/or biometric-based user-element interactions.

FIG. 27 is a graph illustrating an example of employment of AI to aggregate and average user input data recordings for an interaction to determine a baseline of human input for the interaction.

FIG. 28 is a diagram illustrating an example of picture-in-picture functionality used for multiuser picture-in-picture online collaboration within a VR design, development, and prototyping/testing software environment.

FIGS. 29 and 30 are diagrams illustrating different user views of a collaborative multiuser cloud-based spatial design platform.

FIG. 31 is a plan diagram illustrating an example multiuser perspective of a 3D experience environment for providing experiential feedback to a designer.

### DETAILED DESCRIPTION

The introduction and growing popularity of 3D experiences has introduced difficulty and redundancy for traditionally trained design and development professionals when creating 3D UIs and spatial software prototypes. The creation of natural-feeling, human-centered UIs and other 3D spatial experiences can pose challenges to designers and developers of 3D experiences, in part because designers and developers have traditionally only been trained in creating interfaces for 2D web or mobile phone experiences. Design work may be done many times over during iterative user testing between team members and experience developers, such as game engine developers. Such design work can include development of a design layout that can define placements, orientations, and relative spacings of 2D or 3D elements within a 3D space to form, as examples, a 3D environment or a user interface renderable within the environment. Elements can include items, objects, avatars, simulated persons and other beings, buildings and other structures, ground planes and other landform features, light sources, text containers, containers for media elements such as image or video content, UI controls such as text fields, buttons, sliders, knobs, menus, and other controls, and anything else that can be positioned, oriented, and rendered in a scene of a 3D experience. Elements can have various properties, including position and orientation, that can affect how they are displayed within a scene. Positioning, orienting, and, in some cases, animating elements can be part of the 3D experience design process.

Computer-implemented design tools can facilitate the design process. For example, such tools can be used to partially automate element placement, rearrangement, and/or spacing adjustment of elements in a design layout. Each of these design tasks can otherwise involve repetitive input work to move and adjust each element in the design layout. The perception of a design layout and interaction with the design layout of any given user may vary depending on the hardware and/or settings used to perceive or interact with the elements in the layout. User perceptions may vary greatly between different display technologies. For example, a 3D user interface designed to be placed centrally within a user's field of vision and to extend to within a certain desired proportion of the user's field of vision when the user uses a certain HMD to perceive the user interface may appear too large, too small, or poorly situated within the user's field of vision when viewed with a different HMD, or with a non-head-mounted 3D or 2D monitor. Similarly, elements such as UI controls that are well adapted to be interacted with using a certain interaction technology, such an optical gesture recognizer, can be ill adapted to work with a different interaction technology, such as an accelerometer-tracked wand or glove. Rulesets can be implemented to adapt user interfaces for appropriate display and interaction settings depending on the particular display technology and/or interaction technology in use. However, coding these rulesets and fine-tuning a user interface for a wide variety of display technologies or interaction technologies can be laborious.

The 3D spatial design systems, methods, and computer-readable media described herein can afford designers and developers of 3D experiences a streamlined transition between design and development phases of software development, in part by enabling economy of digital interaction. For example, 3D spatial design systems, methods, and computer-readable media described herein can simplify the design and communication process by embodying the methods described herein as a tool that can function as a plugin in game engines. The tool can help ease design of a 3D designs, such as 3D UI designs, and automate aspects of the design of a 3D design or UI that help make the 3D design or UI display in a more natural manner and be interacted with in a more natural manner using a variety of display technologies, interaction technologies, or associated settings. The 3D spatial design systems, methods, and computer-readable media described herein can thus streamline the design process for 3D designs, such as 3D UI designs, used in 3D experiences. The 3D spatial design systems, methods, and computer-readable media described herein can reduce creation time, can ameliorate redundancy in design, can accelerate software prototyping processes, and can alleviate miscommunication between design and development teams creating spatial applications on mobile and head-mounted display devices for 3D experiences.

In various examples, the 3D spatial design systems, methods, and computer-readable media described herein can allow UI designers to create UIs for mobile-based and head-mounted-display-based 3D applications in three dimensions within the same software, such as 3D game engines, that development teams use to code interactions. By streamlining the design and development process, the 3D spatial design systems, methods, and computer-readable media described herein can reduce time-to-authorship for a team creating 3D experiences.

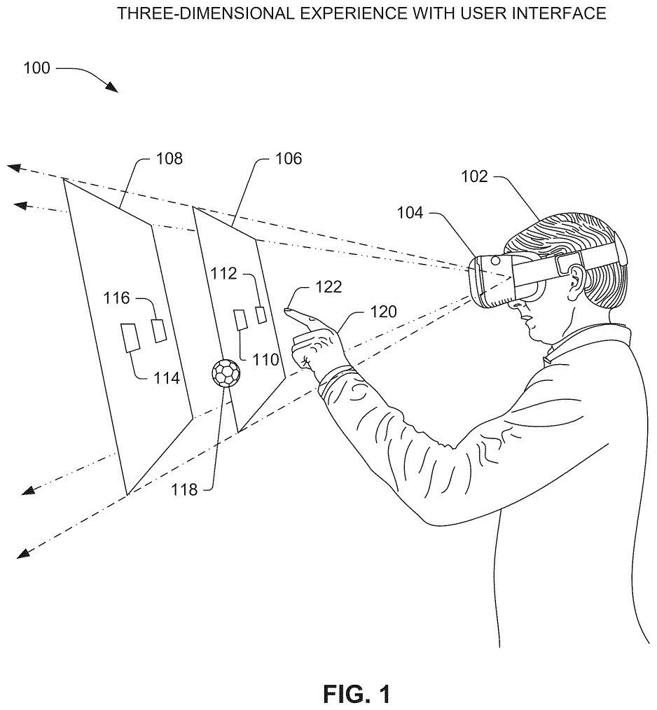

FIG. 1 illustrates an example 3D experience system 100 with a UI. In the illustrated example, a human user 102 wears an HMD 104 having a stereoscopic display to view a 3D experience rendered via the display. The HMD 104 can include one or more cameras configured to capture one or more real-world views of the user as one or more corresponding video streams displayed, in whole or in part, using the display of the HMD 104. For example, in various modes of the system 100, such as an AR mode, the HMD 104 can display the captured video stream(s) superimposed with a digital overlay to present to the user virtual objects, or virtual representations of real-world objects, in the same 3D space as the real-world view perceived using the camera(s) of the HMD 104. The position and orientation of the HMD 104 can be tracked, for example, using one or more accelerometers and/or gyroscopes (not shown) in the HMD 104, using an optical tracking system (not shown), and/or using another tracking technology. The HMD 104 can also utilize a global positioning system (GPS) to determine its position in 3D space on the planet, expressed, for example, in latitude, longitude, and altitude values, to within a certain precision that can be further refined by the aforementioned tracking technology. In other examples, not shown, other display technologies, such as 3D monitors or 3D projection systems, can be used to provide the visual aspects of the 3D experience to the user 102. In some examples, the HMD 104 can include a computing device used to render the 3D experience to the user 102 via the display by processing 3D data to color pixels of the display. The computing device can also composite rendered virtual elements and the captured video stream(s). In other examples, the HMD 104 can be communicatively coupled, wired or wirelessly, to an external computing device (not shown) that is configured to render the 3D experience and to transmit resultant video signals to the display of the HMD 104.

The 3D experience system 100 of FIG. 1 can be used to render to the user 102 a 3D design. The 3D design can include virtual objects in a virtual 3D space rendered to the user via the display in the HMD 104. Such objects can include planes, like planes 106 and 108 in FIG. 1, on which can be rendered 2D or 3D elements, like elements 110, 112, 114, 116. The 2D or 3D elements can include UI controls such as buttons, sliders, knobs, and menus. The objects in the virtual 3D space can also include one or more freely manipulable 3D objects, such as sphere 118. The one or more 3D objects can also serve as elements of the 3D design, or as UI controls, in that their manipulation, such as their translation through space, their rotation, their squeezing/expanding, and so forth, can be translated into numerical inputs that can affect some other aspect of the 3D experience 100 or can be stored for later recall. In some examples, the user can use a hand 120, or multiple hands, and/or a finger 122, or multiple fingers, to manipulate the elements 110, 112, 114, 116, 118, such as by pushing 2D or 3D buttons. The positions and/or orientations of the hand(s) and/or finger(s) can be tracked using a 3D input technology, such as an optical tracker or a glove equipped with one or more accelerometers and/or gyroscopes, and can thereby be used to manipulate the elements 110, 112, 114, 116, 118. In other examples, not shown, the user can use a tracked input device, such as a wand or 3D mouse, to interact with the 3D user interface and manipulate the virtual 3D environment.

In various modes of display, such as AR modes, the system 100 of FIG. 1 can present to the user 102 digitized, rendered versions of real-life geospatial objects, such as buildings, streets, vehicles, items, and/or anatomical features, as part of a digital overlay of a real-world view captured using cameras of the HMD 104. The digitized, rendered real-life geospatial objects can be digitized and/or rendered either by system 100 or by a different system communicatively coupled to system 100. A 3D experience and/or UI presented to the user 102 can be designed for the digital overlay of the real world. The user 102 can be an end user of the 3D experience, or can be a designer of the 3D experience who participates in the 3D design, 3D placement, animation, and interactivity-design of elements within the 3D experience as will be perceived and interacted with by an end user. 3D design can include UI design. A designer may alternatively or additionally use a 2D monitor, not shown, to perform such design work.

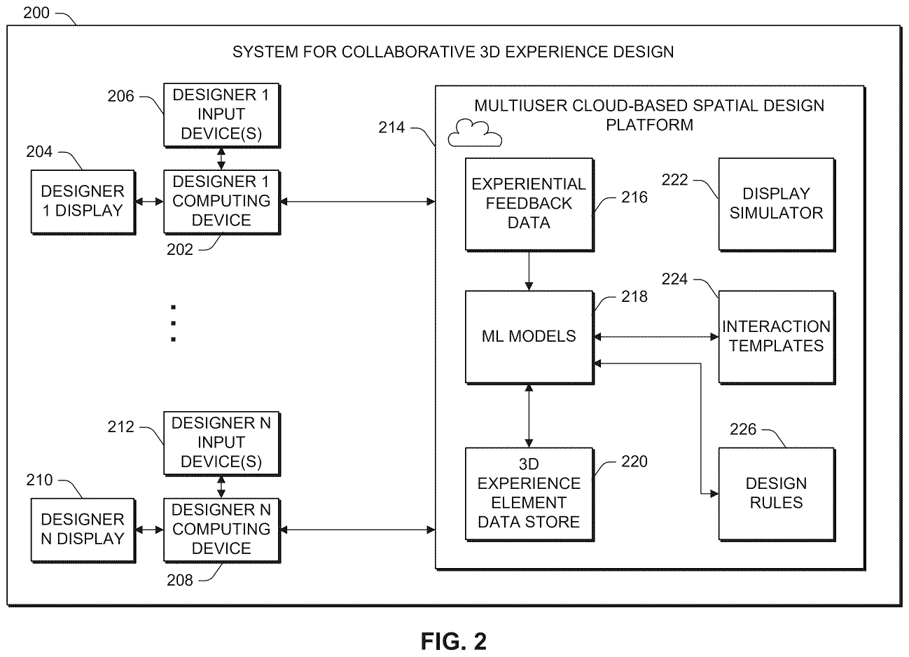

FIG. 2 illustrates an example system 200 for collaborative 3D experience design. The system 200 can include a number N of designer systems including a first designer computing device 202 with a first designer display 204 and a first designer input device 206 and an Nth designer computing device 208 with an Nth designer display 210 and an Nth designer input device 212. Each display device 204 . . . 210 can be, as examples, a 2D monitor, a stereoscopic display of an HMD, or other displays, and can be used by the designers to view a 3D experience under design either from a view of the same designer or from a view of one or more of the other designers. Each display device 204 . . . 210 can send display setting data and display hardware identification data to its respective computing device 202 . . . 208. Each designer input device 206 . . . 212 can provide inputs to its respective computing device 202 . . . 208 such as interactivity inputs that permit respective designers to interact with the 3D experience and elements thereof; video stream inputs that provide a real-world view of each designer, such as may be acquired by one or more video camera sensors of an HMD; or other inputs, such as tracking inputs or GPS inputs. Each designer computing device 202 . . . 208 can be used by a human designer to log into a multiuser cloud-based spatial design platform 214 that facilitates collaborative design work on 3D experience designs. For this purpose, each designer computing device 202 . . . 208 can be communicatively coupled to the design platform 214 via a network such as the internet or an intranet. The spatial design platform 214 can be hosted in the cloud or, in other examples, on a single private server or multiple private servers to which the designer computing devices 202 . . . 208 can access. The spatial design platform 214 can send view data generated within the platform 214 or supplied from various designers to the various designers connected to the spatial design platform 214.

The spatial design platform 214 of FIG. 2 can include a 3D experience element data store 220 in which can be stored elements of the 3D experience and their properties. The spatial design platform 214 can include one or more machine learning (ML) models 218 that can be trained on data from the element data store 220, and/or other data stores (not shown) having design data, in order to later provide inferences as AI-based automatic adjustments or semi-automated recommendations for adjustment that can be used to modify element property data, as described in greater detail below. Design rules 226 can be coded to dictate how element properties should be modified based on display settings, display technologies, spatial location, time, or other factors, for example, in the absence of overriding manually provided design directives or AI-based adjustments. Interaction templates 224 can dictate how elements can be interacted with. Experiential feedback data 216 can be collected from test-user or end-user use of the 3D experience. Data from the design rules 226, interaction templates 224, and experiential feedback data 216 can all be used to train one or more of the ML models 218, in some examples, and in some examples, one or more of the ML models 218 can in turn be used to generate or modify design rules 226 or interaction templates 224.

The spatial design platform 214 of FIG. 2 can further include a display simulator 222 that can be configured to generate display views that replicate or simulate display views of different display technologies, different display hardware, and/or different display settings. A designer using the spatial design platform 214 can have displayed on the designer's own display 204 . . . 210 views that replicate or simulate the various views under which a spatial design may be prototyped, tested, or adjusted. A designer can compare such views, for example, using a split screen, picture-in-picture, or A/B switching to test effects on the 3D experience of different display hardware or settings and/or of manually made element property adjustments, automatically made adjustments made by design rules 226 and/or ML models 218, or user interactions, including affirmative interactions and passive interactions such as user-element proximity, user gaze, or other forms of user attention, as any of these can effect element properties and, accordingly, views of the 3D experience as may be displayed by different displays. A designer may similarly test different interaction setups designed for use with different interaction technologies or under different 3D experience state conditions.

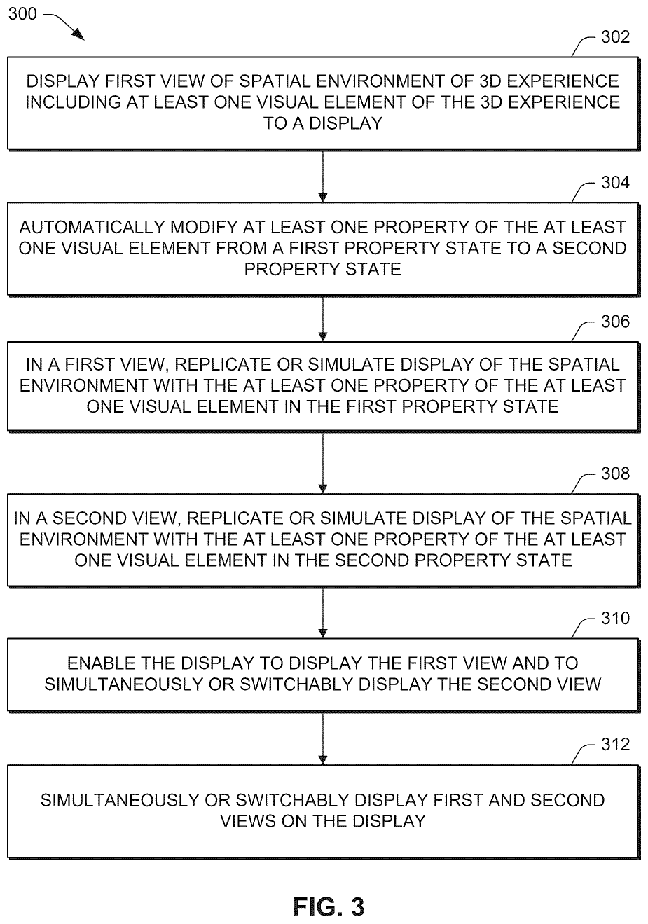

The flow diagram of FIG. 3 illustrates an example method 300 of spatial design. A first view of a spatial environment of a 3D experience, including at least one visual element of the 3D experience, is displayed 302 to a display. The display can be, for example, an HMD or 2D display. At least one property of the at least one visual element of the 3D experience is automatically modified 304 from a first property state to a second property state different from the first property state. As examples, the property state can be a position state, an orientation state, a size state, a color state, a highlighting state, or any other property state of the element, indicative of values associated with any property of the element. As examples, the automatic modification can based on (a) a proximity value indicative of a distance between the at least one visual element and a second element of the 3D experience, such as a user avatar; (b) a design rule; or (c) a trained ML model inference. Display of the spatial environment with the at least one property of the at least one visual element in the first property state is replicated or simulated 306 in a first view. Display of the spatial environment with the at least one property of the at least one visual element in the second property state is replicated or simulated 308 in a second view. The display is enabled 310 to display the first view and to simultaneously or switchably display the second view. The first and second views are simultaneously or switchably displayed 312 on the display. The method 300 thereby allows a comparison between 3D spatial designs and thus permits meaningful interactive modification of designs or the rules or AI-based recommendations that automatically generate them.

The systems, methods, and computer-readable media described herein can aid in the design and creation of 3D experiences in multiple ways. As one example, the systems, methods, and computer-readable media described herein can be capable of aiding in the manual, automated, or semi-automated placement, alignment, orientation, and/or sizing of visual elements of a 3D experience, and/or of manual, automated, or semi-automated adjustments of other properties of such visual elements. Visual elements can include 2D or 3D elements and can include objects, pictures, icons, text, controls, and containers, such as scrollable containers, that can include any of the preceding. Elements can also include control features of elements, such as handles, pivot points, pivot axes, sliders, buttons, or other controls that can be used to adjust properties of elements, such as size or orientation, as examples. For example, handles can serve as control features associated with some property of an element such as its size in a particular dimension, skew in a particular dimension, or orientation (rotation) about an axis in one or more given dimensions. Pivot points or axes are control features that can be defined as references about which other control features, such as handles, can function. For example, an object can be rotated, via user manipulation of a handle, about a pivot point or pivot axis serving as a central point or axis of the rotation. Placement, alignment, orientation, and sizing of visual elements and their control features can be one of the most labor-intensive aspects of 3D experience design, owing the amount of repetition that can be involved and the precision needed to place, align, orient, and/or size a large number of visual elements that may be included in a 3D experience.

Tools that can aid precision of placement, alignment, orientation, sizing, and adjustment of other properties of visual elements include guides, grids, and snap functionality. Other tools that can aid element property adjustment include commands, directives, routines, programs, and ML models that can adjust the properties in ordered ways. As one example, a command can be issued that can adjust the placement of a plurality of selected elements in accordance with a regular distribution or some other form of distribution. As another example, an ML model can be manually or automatically invoked to make an arrangement of elements in accordance with what the ML model has learned to be an acceptable arrangement based on training of a number of prior-designed element arrangements. Methods of element property adjustment can involve using an input device to manually adjust the property, as by a designer using an input device to “grab” the element and manually move it to a desired location in 2D or 3D space, or to grab and manipulate a handle, axis point or axis line, or other control associated with the element. Elements can be placed at coordinates in the real world, at coordinates in a virtual world, or at locations and/or orientations that can be relative to locations and/or orientations of stationary or moving real-world or virtual-world features that can be tracked. As an example of an element placed at a location and orientation relative to a location and orientation of a moving real-world feature, a button or other control of a user interface can be located and oriented relative to a limb of a user, such that the user can access a virtual control panel rendered on the user's limb.

Snap functionality “snaps” a visual element being placed into a desired position relative to the position of another visual element, a guide, or a grid by automatically adjusting the position or orientation of the visual element precisely to the desired position when the visual element is placed approximately at the desired position within some defined tolerances. The precise position and tolerances can be user-defined and/or automatically defined based on some user-provided or automatically determined criteria, procedure, or ML model. An element, such as a UI element, or a handle or other control feature thereof, can be snapped into place relative to real-world coordinates, virtual coordinates, or at locations and/or orientations that can be relative to locations and/or orientations of stationary or moving real-world or virtual-world features that can be tracked. Once snapped, an element or control feature thereof can have its position and/or orientation fixed relative to a stationary or moving reference, or can be animated relative to the snapped position and/or orientation in ways determined by code or other instructions. Snap functionality can be activated or de-activated during the 3D spatial design process.

A grid is a defined repeated spacing, such as a regular periodic or log spacing, having demarcations to which visual elements can be snapped or moved along with precision. The demarcations of a grid can be straight, radial, polar, or can obey a defined curvature. A grid can be manually defined or can be automatically defined, for example, via a procedure or ML model.

A guide is a non-regularly-repeating demarcation that is either user-defined or automatically defined based on a position or orientation of another visual element, or based on a procedure or ML model. For example, a baseline or base plane of first element can be manually or automatically designated to serve as a guide to which a second element, or, for example, a resizing handle thereof, can be snapped. A designer may also manually place a guide to which the user may intend to snap a number of objects during a design process.

Grids and guides can be 2D or 3D, and can be placed, deleted, activated, or de-activated during the 3D spatial design process. In addition to aiding in the placement, alignment, orientation, and sizing of visual elements, grids, guides, and snap functionality can aid in other aspects of design, such as element animation and adjustments of one or more other element properties, such as skew or twist. The manual or automated creation and adjustment of guides and grids, and the enabling or disabling of snap functionality, can be provided as tools or UI elements in a design tool for aiding designers and designing and creating 3D experiences. Selected visual elements can also be aligned or oriented to each other or to a guide or grid upon execution of an alignment command in the design tool. Selected visual elements can also be spatially distributed amongst each other, regularly, logarithmically, randomly, or according to some defined criteria, procedure, or ML model, upon execution of an alignment command in the design tool. These alignments and distributions can be in two or three dimensions, and, insofar as they may take into account a fourth dimension of time, can be in four dimensions.

As another example of how the systems, methods, and computer-readable media described herein are capable of aiding in the design and creation of 3D experiences, the systems, methods, and computer-readable media described herein can aid in the design and creation of 3D experiences that are adaptive to different display technologies or settings. As one example, a user interface for a user of a first HMD having a first resolution and/or a first field of view setting may view a UI that is positioned and proportioned such that all of its text is legible and all of its controls are accessible to the user, but the same UI may display illegibly or inaccessibly to a user when viewed using a second HMD having a second resolution, different from the first resolution, and/or a second field of view setting different from the first field of view setting. Examples of illegibility can include text or graphics that are too miniscule, as displayed, to be adequately deciphered by a human viewer, or that crowd into and/or overlap other elements so as to be obscured by or mix into other elements. Examples of inaccessibility can include one or more buttons or other controls that render “off-screen” or otherwise outside of a desired viewing area, or are crowded, overlapped, or obscured by other elements, such that the one or more buttons or other controls cannot be properly viewed or interacted with. Display rules can be used to define how 3D experience visual element arrangements, such as UI element arrangements, are automatically adjusted based on the display technology used to view them or the interaction technology used to interact with them. These display rules can be tuned by designers and developers so as not to produce anomalous results for different display technologies and/or interaction technologies.

As another example, a UI that is well adapted for display via an HMD may be ill adapted for display via a flatscreen monitor, exhibiting one or more of the same problems described above, and/or hampered by the absence of a depth display dimension relied upon by the 3D display of the HMD to display or make interactable certain controls or other features of the UI. In other examples, during design of a UI for a first display or display technology, UI elements may be placed, arranged, and/or aligned into an aesthetically pleasing configuration or “feng shui”, but upon display using a second display or display technology, for example having a different resolution or field of view, display rules can cause the rearrangement and/or resizing of the UI elements into a configuration that lacks an aesthetically pleasing configuration, even though it may preserve legibility and accessibility. The systems, methods, and computer-readable media described herein can permit viewing and testing of designed UIs and other 3D experience designs in different rule-based configurations simultaneously with each other and/or using switchable A/B comparisons so that designers and developers can ensure that designed experiences display appropriately over a range of different display technologies and settings by customizing designs for the different display technologies and settings and/or by appropriately coding display rules so that designs can adapt to different display technologies and/or settings while preserving legibility, accessibility, and/or pleasing aesthetics. The adaptation can include gracefully degrading when displayed using display technologies of lesser capabilities than those for which the 3D experience was intended.

As another example of how the systems, methods, and computer-readable media described herein are capable of aiding in the design and creation of 3D experiences, the systems, methods, and computer-readable media described herein can be capable of providing to designers and developers AR or MR views that incorporate both actual or simulated real-time video data with rendered virtual elements, so that the designers and developers can test how the rendered virtual elements spatially track with and/or interact with real (or simulated “real”) objects in the actual or simulated real-time video data.

### Units of Measure

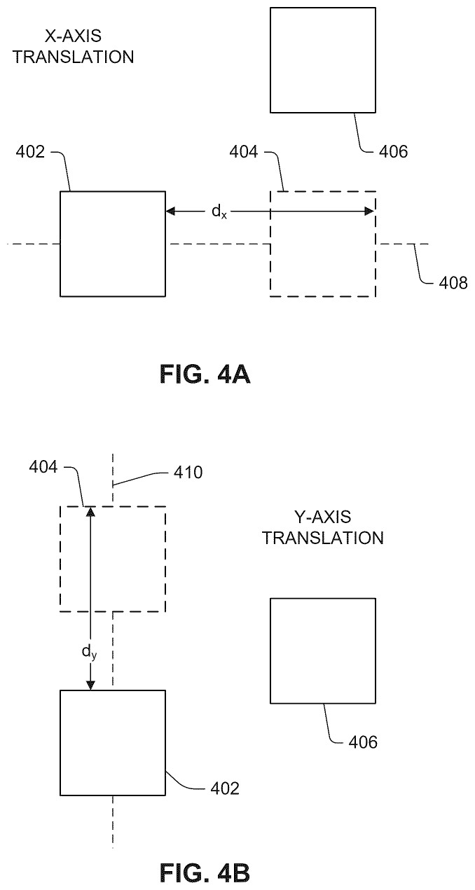

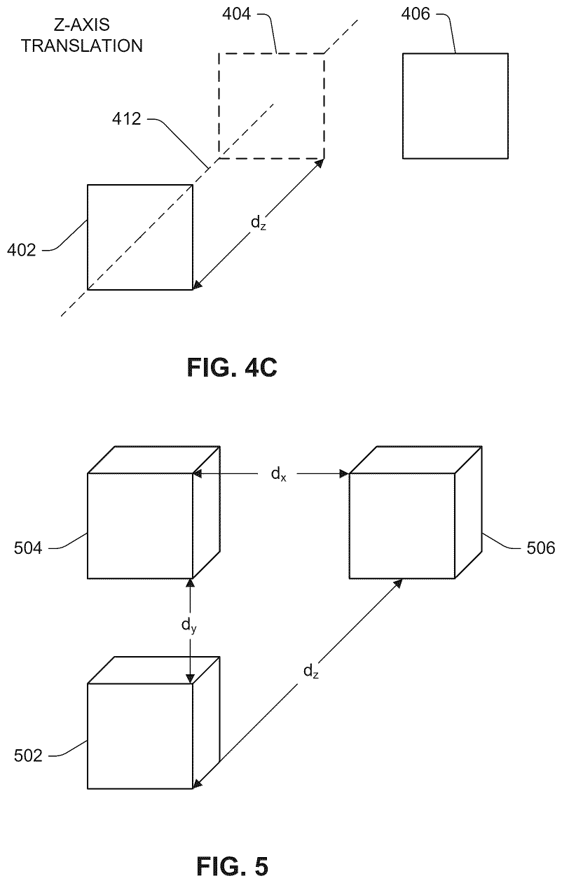

The diagrams of FIGS. 4A, 4B, 4C, 5, and 6 illustrate examples of uses of units of measure, such as translational units of measure, in a 3D space of a 3D experience such as one displayed using the system 100 of FIG. 1. A pixel is the smallest independently renderable portion of a display. The number of pixels in the display depends on the size and resolution of the display. Pixels of a 3D environment or 3D UI rendered to a display device, such as a stereoscopic display of an HMD, can be related to real-world units including longitude, latitude, and altitude. A vertice is an intersection of two lines or curves in 3D space. A distance is a measurable, linear amount of space between two positions in 2D or 3D. Positioning a pixel in alignment with its desired location in the real world allows digital design teams to design 3D experiences “from anywhere, for anywhere” on the planet.

FIGS. 4A, 4B, and 4C show different views of the same elements 402, 404, 406 in 3D space. The elements 402, 404, 406 may be 2D elements or 3D elements, but are drawn in the views of FIGS. 4A through 4C as flat 2D elements for simplicity of illustration. In the first orthographic projection view of FIG. 4A, a translational distance dₓ between a 3D position of a real-world element 402 and a 3D position of its digital counterpart 404 can be measured along a first axis 408 (for example, an X axis). The orthographic projection view of FIG. 4A is such that displacements between elements 402 and 404 in dimensions other than the dimension of the first axis 408 may not be apparent in the view of FIG. 4A. In the illustrated example of FIG. 4A, the real-world element 402 and its digital counterpart 404 are shown in relation to a second element 406. In some examples, FIG. 4A can also illustrate a first-dimension translational distance dₓ by which an element 402 can be moved to position 404 by a 3D experience designer during design, either manually using an interaction technology, via a command or automatically using a program or routine or based on a determination made by an ML model.

In the second orthographic projection view of FIG. 4B, a translational distance d_{y} between the 3D position of the real-world element 402 and the 3D position of its digital counterpart 404 can be measured along a second axis 410 (for example, a Y axis), orthogonal to the first axis 408 in FIG. 4A. The orthographic projection view of FIG. 4B is such that displacements between elements 402 and 404 in dimensions other than the dimension of the second axis 410 may not be apparent in the view of FIG. 4B. In the illustrated example of FIG. 4B, the real-world element 402 and its digital counterpart 404 are again shown in relation to the second element 406. In some examples, FIG. 4B can also illustrate a second-dimension translational distance d_{y} by which an element 402 can be moved to position 404 by a 3D experience designer during design, either manually using an interaction technology, via a command or automatically using a program or routine or based on a determination made by an ML model.

In the third orthographic projection view of FIG. 4C, a translational distance d_{z} between the 3D position of the real-world element 402 and the position of its digital counterpart 404 can be measured along a third axis 412 (for example, a Z axis), orthogonal to both the first axis 408 in FIG. 4A and the second axis 410 in FIG. 4B. The orthographic projection view of FIG. 4C is such that displacements between elements 402 and 404 in dimensions other than the dimension of the third axis 412 may not be apparent in the view of FIG. 4C. In the illustrated example of FIG. 4C, the real-world element 402 and its digital counterpart 404 are again shown in relation to the second element 406. FIGS. 4A, 4B, and 4C can also more generally illustrate translation along X, Y, and Z dimensions, respectively. Distances dₓ, d_{y}, d_{z} can represent distances between elements, pixels, points, or vertices, and can be represented in real-world units such as millimeters or inches. In some examples, FIG. 4C can also illustrate a third-dimension translational distance d_{z} by which an element 402 can be moved to position 404 by a 3D experience designer during design, either manually using an interaction technology, via a command, or automatically using a program or routine or based on a determination made by an ML model.

The orthographic projection view of FIG. 5 shows three 3D elements 502, 504, 506 with labeled distances dₓ, d_{y}, d_{z} between them. The distances in pixels on a display can be correlated to real-world measurement units, such as millimeters or inches, in order to correlate rendered digital shapes in the virtual world with corresponding real-world shapes in the virtual world. In some examples, In some examples, FIG. 5 can illustrate three-dimensional translational distances dₓ, d_{y}, d_{z} by which an element can be moved by a 3D experience designer during design, either manually using an interaction technology, via a command, or automatically using a program or routine or based on a determination made by an ML model.

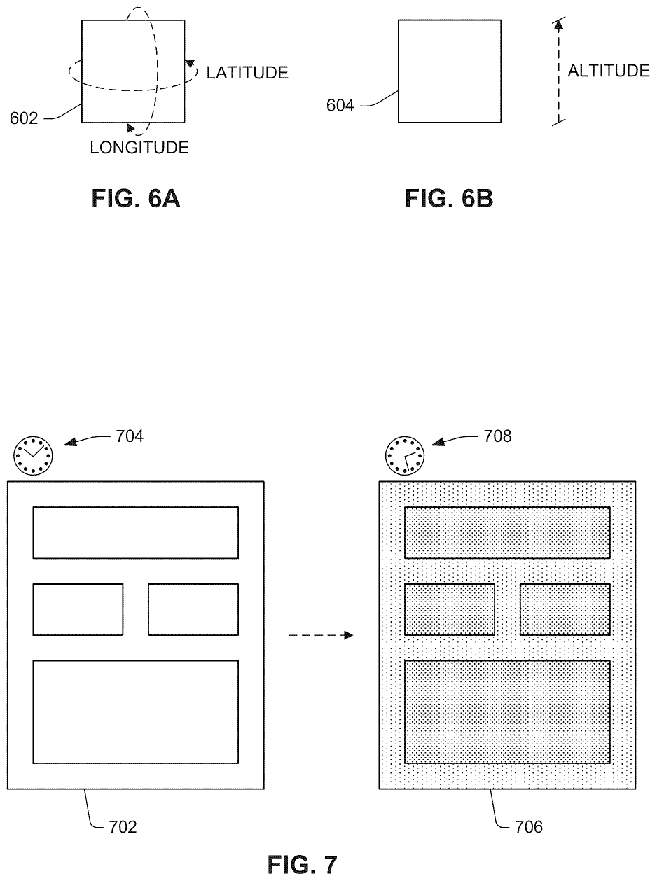

Rendered virtual elements in a display can also have their 3D spatial positions correlated to the 3D spatial positions of real-world elements via forms of measure indicative of placement on the planet, such as latitude, longitude, and altitude. FIG. 6A illustrates latitude and longitude around an element 602. Vertices or pixels of the element 602 can be placed at or relative to or animated about a point defined by longitude and latitude coordinates, which can be made further precise by other values indicating relations with respect to the coordinate. As an example, the coordinate can be based on a real-world coordinate determined by a GPS receiver, such as a GPS receiver held or worn by a user, such as a GPS receiver built into the HMD 104 of FIG. 1. FIG. 6B illustrates an altitude vector labeled with respect to an element 604. Vertices or pixels of the element 604 can be placed at or relative to or animated about a point defined by an altitude value, alone or in conjunction with longitude and latitude coordinates, which can be made further precise by other values indicating relations with respect to the coordinate. As an example, the coordinate can be based on a real-world altitude measurement derived from an altitude sensor, such as a barometric altimeter, or an altitude value determined by a GPS receiver, such as a GPS receiver held or worn by a user, such as a GPS receiver built into the HMD 104 of FIG. 1. An HMD or associated device can include a GPS receiver to provide the latitude, longitude, and altitude of a point of view of a user. Elements can accordingly be rendered by correlating pixels in a display with corresponding latitude, longitude, and altitude values. In at least some embodiments, one or more elements may be anchored (i.e., positioned) at a defined set of coordinates in a virtual world. Accordingly, when a user arrives at or otherwise views a defined latitude, longitude, and/or altitude associated with an anchor point for an element in the virtual world, the element is displayed to the user (e.g., by the HMD 104).

Properties of elements of 3D experiences can change over time, and/or 3D experiences can include dynamic interfaces with elements having properties that automatically adjust with respect to time. 3D experiences can be configured to allow users to experience as digitally generated 3D experience content, including either digitally generated versions of real-world objects and/or locations as they existed in the past, or as they may be estimated or predicted to exist in the future, and/or digitally generated virtual content as it existed in the past or as it may be estimated or predicted to exist in the future, in some instances with this past or future content mixed with presently existing content. Additionally, designers, marketing teams, and engineers may desire to use tools that are capable of displaying past and/or future versions of 3D experience content as a way of planning for future consumption, and thus designing 3D experiences and their UIs in ways that are “future-proofed” against advances in display technologies that may have, for example, resolutions or fields of view greater than possible with present display technology, or finer interactivity resolution than can presently be achieved with contemporary tracking or technology.

FIG. 7 illustrates an example UI 702 having properties that adjust with respect to time. As illustrated, these properties appear as coloration or shading of elements, turning UI 702 at first time 704 into modified UI 706 at second time 708. In different examples, not illustrated, the elements or properties that can change over time or automatically adjust with respect to time can include element position, orientation, size, skew, twist, relative one or more of these properties with respect to other elements, arrangement with respect to other elements, and/or other properties. An element can be automatically included or excluded from display based on time. For example, in at least some embodiments, such an element may be a message or advertisement that is anchored to a window of time (e.g., a start time and date and an end time and date). That is, if the present time in which a user is viewing the UI 702 falls within a defined window of time to which that element is anchored, then the element is displayed in connection with the UI 702. Otherwise, if the present time falls outside of the defined time window, the element is not visible. Further, in at least some embodiments, an element may be anchored to both a set of spatial coordinates (e.g., latitude, longitude, and altitude) as well as a window of time. As an example, a billboard may be visible to a user at a defined location in a virtual world only if the user is viewing that location during the time window to which that billboard is anchored. In some embodiments, a property, such as the content of the billboard may change as a function of which of multiple time periods the user is viewing the billboard. For example, an advertising message displayed on the billboard may change depending on the particular day or time of day that the user views the billboard (e.g., with the HMD 104).

The automatic adjustment of properties of the 3D experience elements can be according to code or other instructions that can be automatically generated by tools of the systems, methods, and computer-readable media described herein. For example, one or more ML models can be trained to perform time-dimension modification of 3D experience element properties based on training data that includes time-dimension alterations of properties of elements. To facilitate time-dependent element property views, modifications, and ML trainings, elements and/or their properties can have timestamps included as metadata associated with the elements and/or their properties. Timestamps and their respective elements and/or properties can be interpolated to arrive at elements/and or properties of an intermediate state between two states defined at different timestamps. Times as represented by timestamps thus can serve as a fourth-dimension unit of measure in addition to the three-dimensional spatial units of measure described above.

### Co-Location and Alignment of Digital Content to Real World Surfaces and Geographic Location

In the context of Augmented Reality applications design, pixels/points of digital content need to be dimensionally aligned where the designer intends a consumer to see the digital content in the real world. Pixels and points can be aligned eventually with infinite resolution to all the complexities of earth, but this solution does create a high need for computing and processing power in real time to account for consumer location, head position, and eye position. Other ways of digitizing and aligning the real world to a digital replica can utilize machine learning/vision, digital twins created from third parties, from scans, photogrammetry, gaussian splatting, neural radiance fields (NeRF) and similar to align digitally created content combined with artificial intelligence understanding of three-dimensional spaces, in real time. Aligning this data with digital content will allow designer to correctly position digital data in the real world but also use this data to mask content behind real world objects with precise depth.

Embodiments of the systems, methods, and computer-readable media described herein may perform co-location and alignment between digital content in relation to real world surfaces through a plurality of imported and comparative data such as digital twins created from third party scans, Gaussian splats, and NeRFs of real-world locations and surfaces. Further, some embodiments may provide co-location and alignment between digital content in relation to real world surfaces through machine learning and vision operations that use user position, head direction, and eye position of the HMD user to achieve alignment with real world locations and surfaces. Some embodiments of the systems, methods, and computer-readable media perform co-location and alignment of digital content using a mixture of the above methods dependent on the priority and availability of mobile devices and edge computer resources in real time. Embodiments of the technologies described herein may provide content storage of said positions and alignments of multiple inputs to create an ever-evolving model of physical locations across time and space. Embodiments of the technologies described herein may provide a near-real time digital twin, iterating at an interval rate of user HMD position pings to a spatial cloud server, such as the platform 214. Some embodiments may provide iterative optimization of 3D data to reduce resolution of vertex, scan, splat, and NeRF data for the purposes of faster real-time interaction between HMDs and digital created positionally accurate content across time.

### Spatial User Interface Responsiveness

The systems, methods, and computer-readable media described herein can provide design and test tools for designing 3D experience UI elements such as text, graphical elements, colors, distances between objects, x-, y-, and z-axis alignment, and interaction types such as clicking, hovering, and scrolling. The 3D experiences can be designed with a combination of 2D interfaces, such as those used with traditional 2D displays as found on computer monitors and smartphone and tablet devices, and 3D displays, as found in HMDs, for eventual display using devices of a variety of device types, including smartphones, tablets, computer monitors, and HMDs that display various levels of VR, AR, and XR.

To account for the multiplicity of device types that may be used to display 3D experiences, a designer or developer can be assisted by a UI interface template that is dynamically responsive, in real time or near real time, based on the type of device used to display the 3D experience. The UI interface template can dynamically define the positioning, arrangement, padding, orientation, and other properties of UI elements, all in 3D space and, in some examples, in a fourth dimension of time, based on the type of visual display technology used to display the 3D experience and the settings of the display technology. The dynamic UI display definition can be in accordance with coding in a computer language such as a procedural language, an object-oriented language, a markup language, or a scripting language. The dynamic UI display definition coding can be automatically generated by a design tool in accordance with the systems, methods, and computer-readable media described herein UI elements of the UI interface templates can dynamically change based upon a display device's size, pixel resolution, field of view (FOV), the ability of the display device to show depth (a “third dimension” or “third axis”), the time (a “fourth dimension” or “fourth axis”), and/or the global position (as may be determined using GPS) at which the 3D experience is displayed, as may be expressed by latitude, longitude, and altitude values, for example.

In examples, the systems, methods, and computer-readable media described herein provide design tools to help a 3D experience designer design for a variety of display devices and to help a 3D experience developer code for designs that are responsive to the variety of display devices. In examples, the design tools can further help designers and developers understand how UI elements are positioned, spaced, aligned and placed in geography, X/Y/Z space, and time, and thus can ease the design of 3D experiences that are practical to create and enjoyable or useful for end users to experience and/or interact with.

In some examples, one or more properties of an element of a 3D experience can be configured to change with respect to display settings. In some examples, a 3D experience can include one or more dynamic interfaces with one or more elements having properties that automatically adjust with respect to display settings. In some examples, an element of a 3D experience can be automatically included or excluded from display based on display settings. Such display settings can include, as examples, display theme, such as dark mode, light mode, or some other color mode, which can be made to be adaptive with respect to time; display scale; display font size; display colors or display brightness, such as may be controlled by one or more color curves or gamma curves; display resolution; display refresh rate; display bit depth; and field of view of a display in one or more dimensions. Field of view can be changed or adapted in different dimensions independently or coordinately. As examples, a horizontal field of view of a display can be changed without changing a vertical field of view of the display, or vice-versa, or both can be changed at the same time.

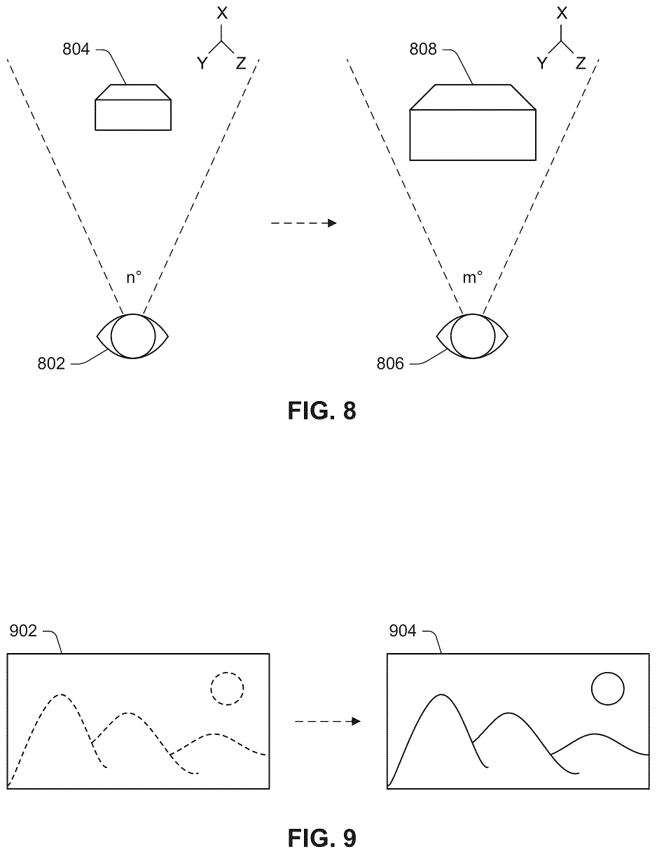

As one example, FIG. 8 illustrates a 3D experience element 804 having properties that adjust with respect to display field of view. The adjusted properties in the illustration of FIG. 8 are horizontal and vertical size of the element 804, but the elements or properties that can change with respect to display field of view or can automatically adjust based on display field of view can include element position, orientation, size, skew, twist, color, transparency, relative one or more of these properties with respect to other elements, spatial arrangement with respect to other elements, and/or other properties. In some examples, the automatic adjustment of properties of the 3D experience elements, or inclusion/exclusion of such elements, can be according to code or other instructions that can be automatically generated by tools of the systems, methods, and computer-readable media described herein. In some examples, the automatic adjustment of properties of the 3D experience elements, or inclusion/exclusion of such elements, can be based on an AI recommendation of the systems, methods, and computer-readable media described herein. In the illustration of FIG. 8, the size of 3D experience element 804 at a first field of view 802 of n° is automatically adjusted to a different size to become 3D experience element 808 when the first field of view 802 is changed or adjusted to m° to become second field of view 806. The element 804 thus exhibits dynamic responsiveness based on display settings.

As another example, FIG. 9 illustrates 3D experience elements 902 having transparency or visibility properties that adjust with respect to display settings. In the illustration of FIG. 9, background elements such as distant mountains and sun 902 have a first level of transparency, or are excluded from display, under a first display setting condition, and have a second level of transparency, different from the first level of transparency, or are included in display, under a second display setting condition, different from the first display setting condition, to become distant mountains and sun 904. In some examples, the dynamic adaptation shown in FIG. 9 can be according to code or other instructions that can be automatically generated by tools of the systems, methods, and computer-readable media described herein. In some examples, the dynamic adaptation shown in FIG. 9 can be based on an AI recommendation of the systems, methods, and computer-readable media described herein. The elements 902 thus exhibit dynamic responsiveness based on display settings.

In examples, UI elements can be configured to exhibit dynamic responsiveness to adjust size based on a of field of view, based on a distance or proximity of an element to a user, to another element, or between users, or based on an aspect ratio or resolution of a display, such as an HMD.

In some examples, one or more properties of an element of a 3D experience can be configured to change with respect to display hardware specifications. In some examples, a 3D experience can include one or more dynamic interfaces, such as one or more dynamic UIs, with one or more elements having properties that automatically adjust with respect to display hardware specifications. An element of a dynamic interface can be automatically included or excluded from display based on display hardware specifications. Such display hardware specifications can include, as examples, display size, display aspect ratio, display resolution, display pixel density, display refresh rate, and display color gamut. As display hardware specifications can differ between manufacturers, models, and types of displays, the elements of 3D experiences can thus be designed to be automatically adaptable to the different display hardware specifications of different display hardware as may be variously employed to view a 3D experience.

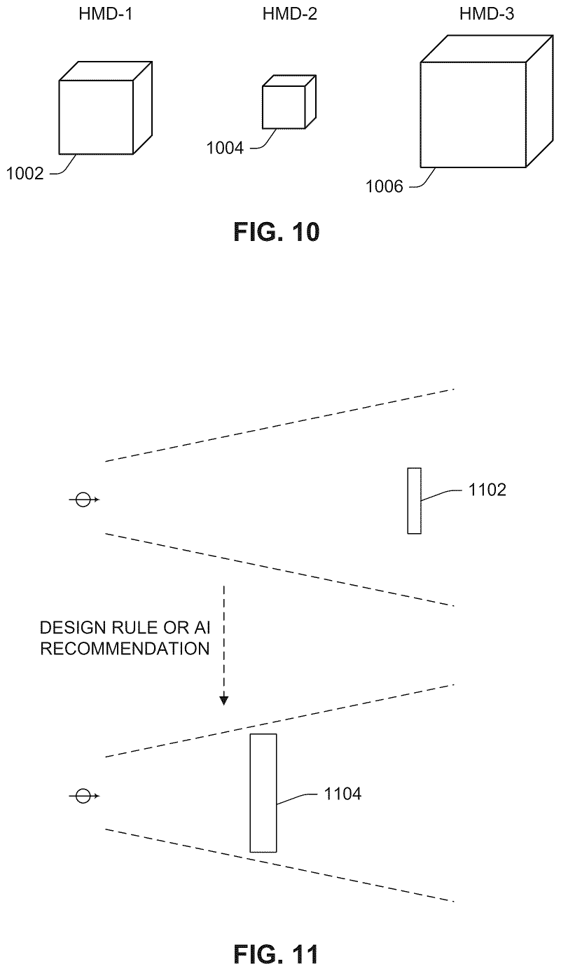

As an example, FIG. 10 illustrates a 3D experience visual element 1002 having properties that adjust with respect to display aspect ratio. The adjusted properties in the illustration of FIG. 10 are horizontal and vertical size of the element 1002, but the elements or properties that can change with respect to display aspect ratio or automatically adjust based on display aspect ratio can include element position, orientation, size, skew, twist, color, transparency, relative one or more of these properties with respect to other elements, spatial arrangement with respect to other elements, and/or other properties. In some examples, the automatic adjustment of properties of the 3D experience elements, or inclusion/exclusion of such elements, can be according to code or other instructions that can be automatically generated by tools of the systems, methods, and computer-readable media described herein. In some examples, the automatic adjustment of properties of the 3D experience elements, or inclusion/exclusion of such elements, can be based on an AI recommendation of the systems, methods, and computer-readable media described herein. In the illustration of FIG. 10, the size of element 1002 as viewed using first display hardware, such as a first HMD, having a first aspect ratio is different from the size of the same element, illustrated as element 1004, viewed using second display hardware, such as a second HMD, having a second aspect ratio different from the first aspect ratio, and is also different from the size of the same element, illustrated as element 1006, viewed using third display hardware, such as a third HMD, having a third aspect ratio different from the first and second aspect ratios. The element 1002 thus exhibits dynamic responsiveness based on display aspect ratio, as one example of dynamic responsiveness based on display hardware specifications.

Design tools of the systems, methods, and computer-readable media described herein can include a feature to auto-align visual elements in an x, y, and/or z axis (along first, second, and/or third spatial dimensions) and/or to auto-align visual elements in time (along a fourth, temporal dimension). UI elements can be configured to exhibit dynamic responsiveness of spacing or padding between elements in an x, y, and/or z axis based on field of view or other settings of a display, such as an HMD.

### Proximity-Based Interactions

Just as human beings interact with objects and persons within the real world, spatial design engineers and UI designers and developers can make use of UI templates to create spatial relationships based upon the relative proximity to one another of elements and/or users that inhabit the virtual spatiotemporal environment of a 3D experience. A 3D experience designer who designs a spatial experience for a VR, AR, or XR application, or a UI designer who designs a UI for such an application, may consider the nature of space, proximity, and/or approach by which an end user may perceive or engage with digital elements of the 3D experience, and may consequently design the 3D experience or UI thereof either based on the nature of space, proximity, and/or approach, and/or may configure one or more elements of the 3D experience to be dynamically responsive to the nature of space, proximity, and/or approach. As examples of the nature of space, an element of a 3D experience can be configured to appear larger in a large room of the 3D experience and relatively smaller in a small room of the 3D experience, or brighter in a bright room and relatively darker in a dark room. As an example of proximity, an element of a 3D experience can be configured to appear larger (over and above the effects of 3D perspective) the nearer a user is to the element. As an example of approach, an element can be configured to take on a first spatial orientation when a user views or approaches it from a first direction or point of view, such as a front of the element, and to take on a second spatial orientation, different from the first spatial orientation, when the user views or approaches the element from a second direction or point of view, different from the first direction or point of view, such as a back of the element. In the context of digital objects within 3D spatial experiences that can exist in an entirely virtual reality or a persistent digital reality that overlays the real world, a user can interact with a multitude of other users, digital avatars, and digital elements, such as digital objects.

In some examples, properties of an element of a 3D experience can be configured to automatically change based on spatial relationships between a user or portion of a user, as existing within the real world or as represented within the 3D experience, and the element or other elements of the 3D experience, based on relationships between different users or portions of different users, and/or based on relationships between different elements of the 3D experience. In some examples, 3D experiences can include dynamic interfaces with elements having properties that automatically adjust with respect to such relationships. An element can be automatically included or excluded from display based on such relationships. Such relationships between users and/or elements can include proximity, relative positioning, relative motion or speed, visibility or obscurity, or other relationships. Proximity between two users or portions of users, between a user or user portion and an element, or between elements can be measured, as examples, in real-world units such as meters, centimeters, feet, inches, or miles, or can be measured in display units such as pixels.

As an example, FIG. 11 illustrates 3D experience element 1102 having one or more properties that adjust with respect to user proximity. The user proximity can be measured with respect to a variety of different points of the user, including minimum distances, maximum distances, average distances, and distances to geometrically central points. As examples, the user proximity can be with respect to a geometrically central point of a user's body or the body of a user avatar, with respect to a minimum distance to a user portion or avatar portion, such as to a fingertip, or with respect to some real or virtual object held by a user or user avatar. In the illustration of FIG. 11, element 1102 has a first size at a first distance from the user, which is automatically adjusted to a second size, different from the first size, at a second distance from the user, different from the first distance. More specifically, in the illustrated example, when nearer to a user, within a manually- or automatically-defined proximity threshold, element 1102 enlarges to become element 1104. Element 1104 can, for example, be a UI element, such as a button or other control. In some examples, the dynamic adaptation shown in FIG. 11 can be according to design rules, code or other instructions that can be automatically generated by tools of the systems, methods, and computer-readable media described herein. In some examples, the dynamic adaptation shown in FIG. 11 can be based on an AI recommendation of the systems, methods, and computer-readable media described herein. The AI recommendation can be made, for example, by an inference of an ML model trained using element proximity data. The element 1102 thus exhibits dynamic responsiveness based on user proximity, as one example of user-user, user-element, or element-element relationship dependence of element property dynamic adjustment.

In examples, UI elements can be configured to exhibit dynamic responsiveness of spacing or padding between elements in an x, y, and/or z axis based on proximity or distance to an object, such as a z-axis distance to an object, either between a user and the object, between objects, or between users. In examples, UI elements can be configured to exhibit dynamic responsiveness of spacing or padding between elements in an x, y, and/or z axis based on an aspect ratio, resolution, and/or other hardware specifications of a display, such as an HMD.

Proximity can be determined by measurement of distances, that is, by the magnitude of a difference vector determined by subtraction of position vectors in 3D space. Interactions based on proximity can be based on determined distances that are, as examples, between a user and another user, between a digital avatar of a user and another user, between a user and a digital avatar of a user, between two digital avatars of different users, between a point representative of the position of a plurality of users and a point representative of the position of another plurality of users, between a real-world object and another real-world object, between a visual element and a real world object, between a visual element and another visual element, between a point representative of the position of a plurality of elements or objects and a point representative of the position of a another plurality of elements or objects, between a point representative of the position of a plurality of users and a point representative of the position of a plurality of elements, a point representative of the position of a plurality of users and a point representative of the position of a plurality of real-world objects, and between a point representative of the position of a plurality of elements and a point representative of the position of a plurality of digital user avatars.

### Attention-Based Interactions

Just as human beings interact with objects and persons within the real world, spatial design engineers and UI designers and developers can make use of UI templates to create these spatial relationships based upon estimated or predicted attention of a user within a 3D experience. A designer designing a 3D experience or UI for a VR, AR, or XR application can, for example, consider the nature of the user's gaze as a form of interaction. Whereas a conventional UI may require an active user input such as a mouse click, keyboard strike, or touch-sensitive screen tap as an interaction form, a 3D experience UI may utilize a more passive input such as user gaze as an alternative or preferred interaction form. Gaze can be determined, as examples, by eyeball tracking or more coarsely by head orientation tracking. Cameras, accelerometers, and/or gyroscopes may be provided in or associated with an HMD or other display or interaction technology to achieve gaze determination.

Attention-based interactions, such as gaze-based interactions, can be a useful predictor of a user's intent regarding a next affirmatively made user interaction. A designer or developer can, as an example, design or program dynamic element property adjustments that are based on user gaze or other attention indicators. Planning for 3D experience element property adjustments upon gaze indicators or other attention indicators can help a designer create compelling spatial experiences and interactions. In addition to gaze, indicators upon which user interactions can be based can include gestures or facial expressions; embodied interactions; vocal expressions that are not necessarily explicit voice commands, such as screams, yelps, sighs, snores, or vocalizations of interest, confusion, understanding, awe, disinterest, or boredom such as “ooh” s, “huh” s, “ah” s, or “um” s; physics-based interactions, such as proximity or collision; haptic- or touch-based interactions; and bio-tracking interactions such as electrocardiogramased, heart-rate-based, or electroencephalography-based (brainwave-based) interactions.

In the context of digital objects within spatial experiences that can exist in an entirely virtual reality or a persistent digital reality that overlays the real world, any user can focus attention on any of a multitude of other users, digital avatars, real-world objects, and/or digital objects. Interactions based on estimated or predicted user attention can be, as examples, based on attention between a user and another user, between a digital avatar of a user and another user, between a user and a digital avatar of a user, between two digital avatars of different users, between a plurality of users or user avatars and a plurality of users or user avatars, between a user or user avatar and a plurality of users or user avatars, between a plurality or users or user avatars and a user or user avatar, between a user or user avatar and a real-world object, between a user or user avatar and a digital object, between a user or user avatar and a plurality of elements or objects, or between a plurality of users or user avatars and a plurality of elements or objects.

Table 1 provides a framework for the types of interactions that may occur between different aspects of a 3D experience in the context of either proximity-based or attention-based interactions, where gesture or facial interactions are denoted by i1, embodied interactions are denoted by i2, vocal interactions are denoted by i3, physics-based interactions are denoted by i4, haptic- or touch-based interactions are denoted by i5, and bio-tracking interactions are denoted by i6.

TABLE 1

| | | Digital | Physical | Real | Virtual | VR |
|---|---|---|---|---|---|---|
| | User | object | object | world | world | character |
| User | i1, i2, i3, | i1, i2, i4, i5 | i1, i2, i3, | i1, i2, i5 | i1, i2, i3, | i1, i2, i3, |
| | i4, i5, i6 | | i4, i5, i6 | | i4, i5, i6 | i4, i5 |
| Digital | i1, i2, i4, i5 | i4 | i4 | i4, i5 | i4 | i1, i2, i3, i4 |
| object | | | | | | |
| Physical | i1, i2, i3, | i4 | — | — | i1, i2, i4, i5 | i1, i2, i4, i5 |
| object | i4, i5, i6 | | | | | |
| Real world | i1, i2, i5 | i4, i5 | — | — | i4 | — |
| Virtual | i1, i2, i3, | i4 | i1, i2, i4, i5 | i4 | i4 | i1, i2, i3, |
| world | i4, i5, i6 | | | | | i4, i5, i6 |
| VR | i1, i2, i3, | i1, i2, i3, i4 | i1, i2, i4, i5 | — | i1, i2, i3, | i1, i2, i3, i4 |
| character | i4, i5 | | | | i4, i5, i6 | |

### Design Tool Automatic Alignment

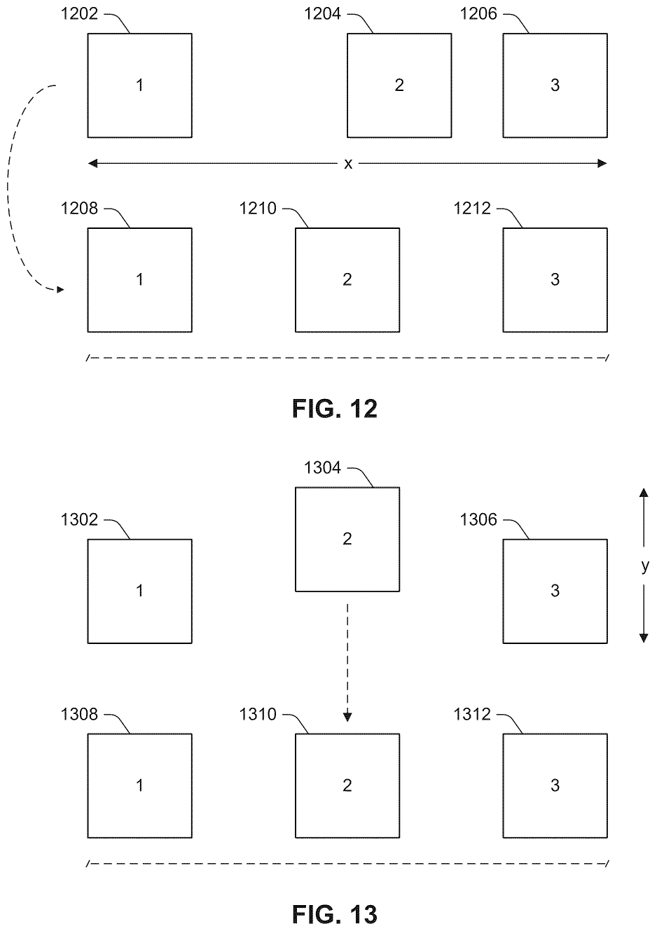

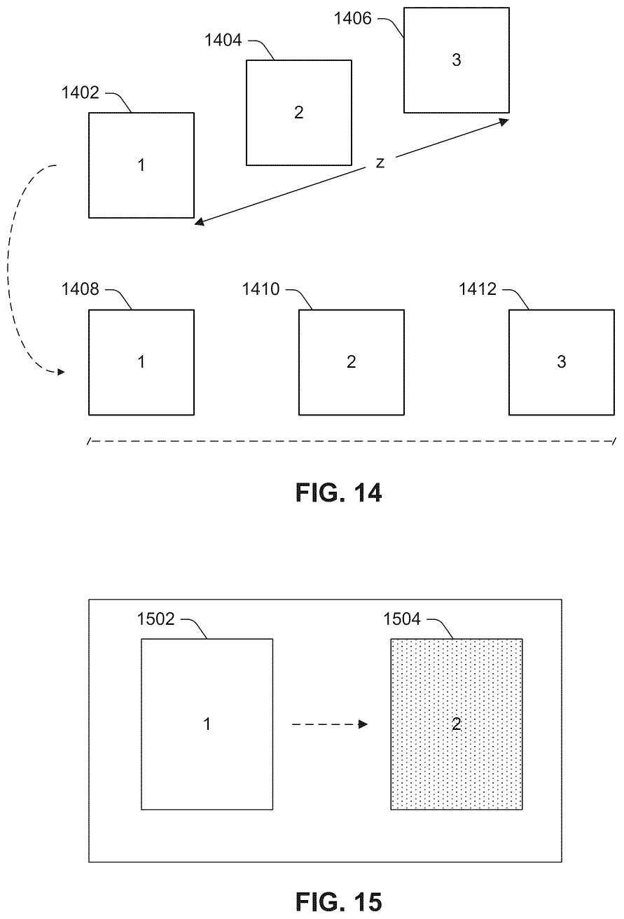

In examples, design tools of the systems, methods, and computer-readable media described herein can include a feature to auto-align visual elements in an x, y, and/or z axis (along first, second, and/or third spatial dimensions) and/or to auto-align visual elements in time (along a fourth, temporal dimension). FIG. 12 shows an example of automatic alignment of a second visual element 1204 in the x axis (along a first spatial dimension) so that it is regularly distributed amongst first and third visual elements 1202, 1206. The auto-distributed elements 1202, 1204, 1206 thus become elements 1208, 1210, 1212, respectively. FIG. 13 shows an example of automatic alignment of a second visual element 1304 in the y axis (along a second spatial dimension) so that it is aligned with first and third visual elements 1302, 1306. The auto-aligned elements 1302, 1304, 1306 thus become elements 1308, 1310, 1312, respectively. FIG. 14 shows an example of automatic alignment of a second visual element 1404 in the z axis (along a third spatial dimension) so that it is aligned with first and third visual elements 1402, 1406. The auto-aligned elements 1402, 1404, 1406 thus become elements 1408, 1410, 1412, respectively. As spatial positions and other element properties can be configured to change with time, tools of the systems, methods, and computer-readable media described herein can include a feature to auto-align visual elements with respect to a fourth, temporal dimension. For example, the position of one element can dynamically track with respect to the position of another element that moves over the course of a time period.

### AI-Based Design Recommendations

An ML model can be trained on 3D experience design data and/or user interaction data so that the model can subsequently make inferences based on 3D experience design and/or user interaction inputs. As aggregated commonalities between user interaction designers are incorporated into the ML model, new design elements can be automatically recommended to a designer by the ML model during the design of a 3D experience, and 3D experience design tools can incorporate such AI-based design recommendations. Because standards for spatial interactions are in their infancy and are continually evolving, AI recommendations can be all the more beneficial in the context of spatial experience design, where incomplete or underdeveloped standards may as yet provide little guidance to designers in designing 3D experiences.

An AI-based design suggestion tool can provide a design suggestions based on aggregated human behavior when designing and consuming spatialized content. As examples, AI-based design recommendations can provide design recommendations as to color saturation, font legibility, proximal distance scale, UI element distance from a user in one or more spatial dimensions, UI element distance from other elements in one or more spatial dimensions, or priority of assigned HMD classes or fields of view. AI-based design suggestions can be made and implemented at design time, by a 3D experience designer, or automatedly at 3D experience runtime so as to affect the 3D experience as perceived by an end user even without designer input, in the latter case. AI-based design suggestions can, in some examples, be based upon real world surface recognition or digital world surface recognition.

As an example, FIG. 15 illustrates a 3D experience visual element 1502 having an AI-suggested property modification provided to a designer during a design phase of the element 1502. The particular design recommendation in the example of FIG. 15 a color saturation design recommendation, but the element property for which a design change recommendation can be automatically suggested can include element position, orientation, size, skew, twist, color, transparency, relative one or more of these properties with respect to other elements, spatial arrangement with respect to other elements, and/or other properties. The AI-based design recommendation can be a general recommendation of one or more design parameters for all display devices, or can be a recommendation for one or more design parameters employed when using a particular display device or display technology. In the illustration of FIG. 15, the color saturation of element 1502 is suggested to be increased, so as to result in more color-saturated element 1504. The AI-based design suggestion in the example of FIG. 15 can be made in an automated or semi-automated manner. When made in an automated manner, the AI-based design suggestion is automatically implemented without designer approval, and it is left to the designer to revert the automated modification if it is disapproved. When made in a semi-automated manner, the designer can be prompted to accept or reject the AI-based design suggestion.

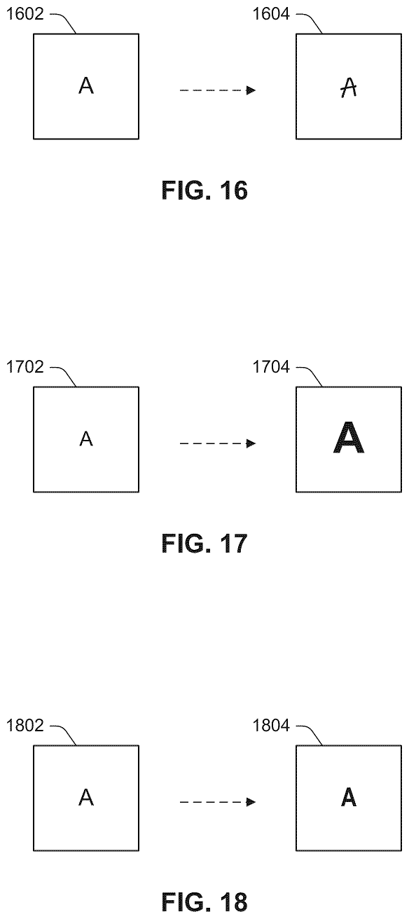

As still other examples, FIGS. 16, 17, and 18 illustrate 3D experience visual elements 1602, 1702, 1802 having AI-suggested font property modifications provided to a designer during a design phase of the elements 1602, 1702, 1802, intended to promote text legibility with proximal distance or scale. The particular design recommendation in the example of FIG. 16 is a font typeface design recommendation, with the font used to render text in element 1602 suggested to adjusted to a different typeface, so as to result in a more legible element 1604. The particular design recommendation in the example of FIG. 17 is a font variation and font size design recommendation, with the font used to render text in element 1702 suggested to adjusted to a larger and bolder font, so as to result in a more legible element 1704. The particular design recommendation in the example of FIG. 18 includes a font variation and typeface design recommendation, with the font used to render text in element 1802 suggested to adjusted to a narrower and bolder typeface, so as to result in a more legible element 1804. The illustrated examples are intended to show but a few of the practically infinite variety of design recommendations that can be made to improve legibility, and the particular design recommendations that may be made can depend on such factors as the intended display technology or display hardware, the scene in which the element is placed, the intended user-element proximity, and, potentially, user-based factors such as eyesight limitations of the particular user engaging with the 3D experience. The AI-based design suggestions in the examples of FIGS. 16, 17, and 18 can be made in an automated or semi-automated manner, as described above.

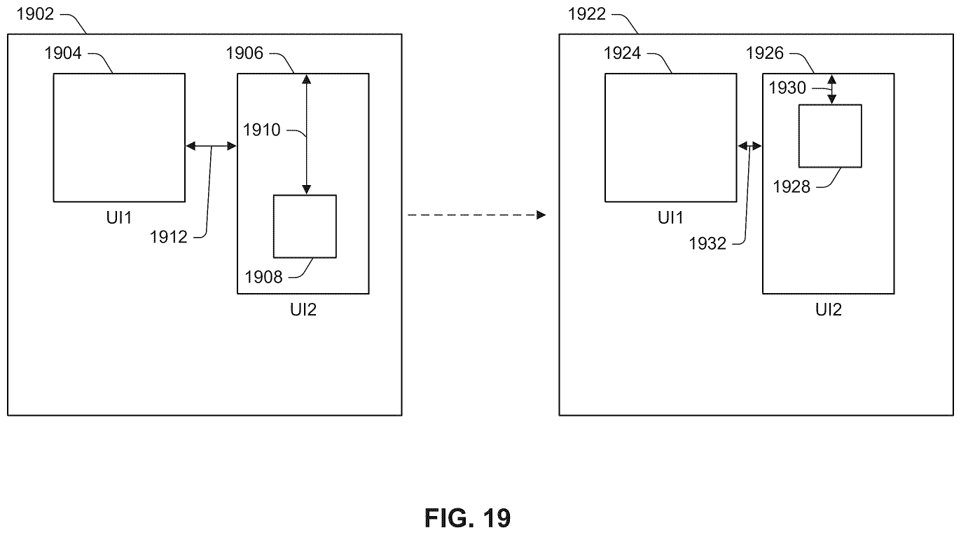

As yet another example, FIG. 19 illustrates a first arrangement 1902 of 3D experience visual elements 1904, 1906, 1908 having a AI-suggested property modifications provided to a designer during a design phase of the element arrangement 1902, to result in second arrangement 1906. The particular design recommendations in the example of FIG. 19 include element spacing and arrangement recommendations, but, as noted above, the element properties for which a design change recommendation can be automatically suggested based on ML inferencing can include a variety of element properties, and the AI-based design recommendations can be general, for all display devices, or specific to a particular display device or display technology. In the illustration of FIG. 19, AI-based recommendations are made to decrease the horizonal (x-dimension) spacing 1912 between a first UI 1904 and a second UI 1906, as spacing 1932, and to decrease the vertical (y-dimension) distance 1910 between the top of an element 1908 of the second UI 1906 and the top of the second UI 1906, as distance 1930, so as to result in an improved arrangement 1922 of visual elements. The improvement can be in the form of legibility, interactivity, aesthetic arrangement, or some other value or combination of values. Elements 1904, 1906, and 1908 in arrangement 1902 are thus shown as corresponding elements 1924, 1926, and 1928 in arrangement 1922. The AI-based design suggestions in the example of FIG. 19 can be made in an automated or semi-automated manner, as described above.

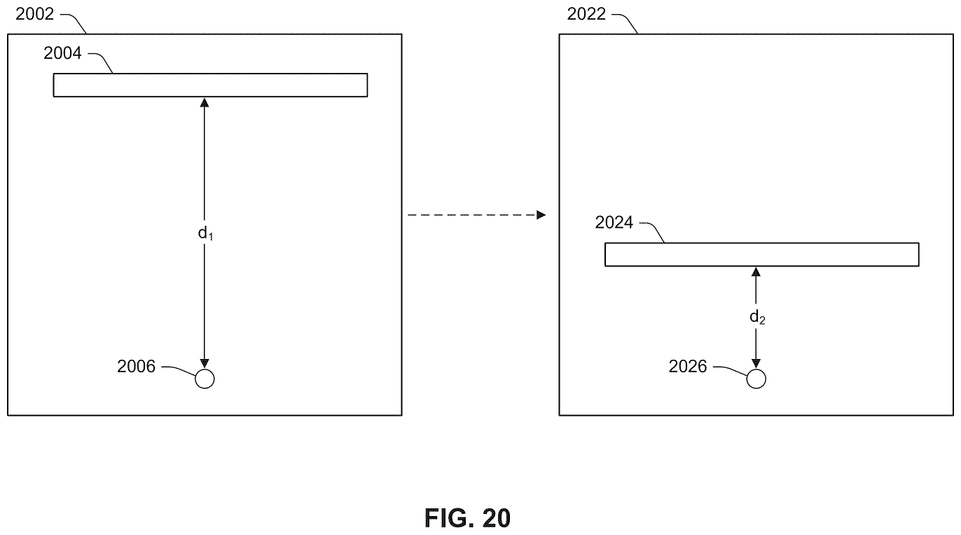

As still another example, FIG. 20 illustrates a first distance d₁ between an element 2004 and a user 2006 in a first arrangement 2002 of a 3D experience having an AI-suggested property modification provided to a designer during a design phase of the element arrangement 1902, to result in second arrangement 2022 with element 2004, shown in the second arrangement 2022 as element 2024, a second, closer distance d₂ to the user 2006, shown in arrangement 2022 as user 2026. The particular design recommendation in the example of FIG. 20 is based on priority of assigned HMD classes and/or fields of view. The AI-based design suggestion in the example of FIG. 20 can be made in an automated or semi-automated manner, as described above.

An ML model can also be trained to provide inferences that yield AI-based interaction recommendations. As an example, AI-based interaction recommendations can be used to generate interaction templates, including multiuser interaction templates. In the context of 3D experiences, an interaction template is a predefined framework or pattern used by a designer to create consistent and intuitive user interactions within a virtual environment. The interaction template guides the design of user interfaces, gestures, and actions, enhancing user engagement and ease of use in an immersive space. An example interaction template in VR is a “gaze and select” mechanism. In this template, a user can navigate a virtual environment by looking at (gazing at) an object or UI control, and a selection can be made by a specific action, such as a button press on a controller. For example, in a VR menu, a user can navigate through options displayed as a list in the menu by looking at the options in the list, and when the user's gaze rests on a desired option, a button press on a control confirms the selection. The interaction template provides a natural and intuitive way for the user to interact with virtual elements, creating a consistent and user-friendly experience across different VR applications. Other interaction mechanisms that can be supported by interaction templates can include “grab and move” or “grab and manipulate” mechanisms, swipe or pointing gestures mechanisms, voice commands, teleportation as a virtual world navigation mechanism, haptic feedback, and menu interactions.

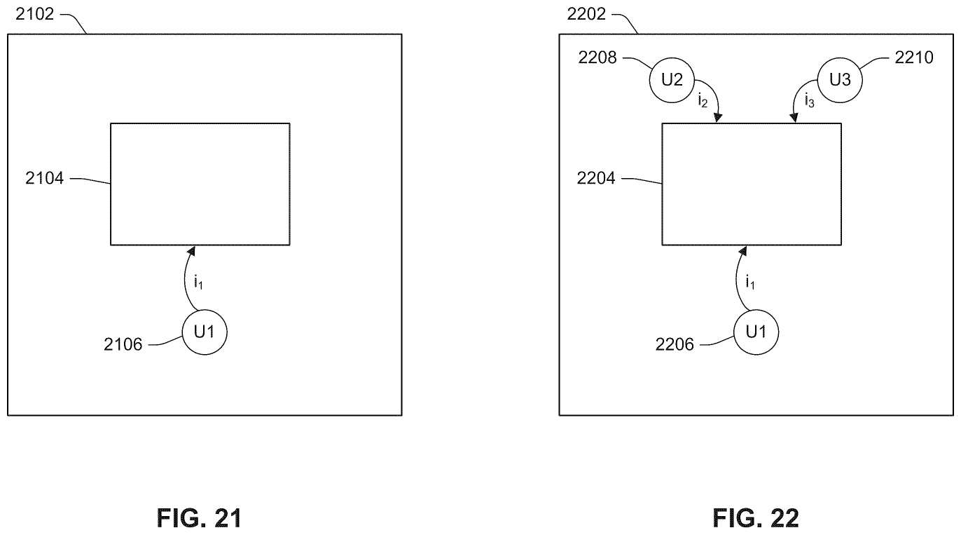

FIG. 21 illustrates an example interaction template i₁ generated using an AI-based interaction recommendation. The interaction template i₁ is used by a first user 2106 to interact with an element 2104 in a 3D experience environment 2102. The interaction template can be generated by an ML model trained using other elements and interaction templates. FIG. 22 illustrates an example multiuser interaction template generated using an AI-based interaction recommendation. The multiuser interaction template includes a first interaction template i₁ used by a first user 2206 to interact with an element 2204 in a 3D experience environment 2202, a second interaction template i₂ used by a second user 2208 to interact with the element 2204, and a third interaction template is used by a third user 2210 to interact with the element 2204. The multiuser interaction template can be generated by an ML model trained using other elements and interaction templates, such as multiuser interaction templates.

As still other examples, AI-based interaction recommendations can be used to generate attention or distraction templates. In the context of 3D experiences, an attention template is a design approach that guides a designer or developer in directing an end user's attention to one or more specific elements in a virtual environment. An attention template can involve, as examples, a preestablished and consistent set of visual cues, such as highlighting, enlargement, motion, or animation of one or more elements, and/or audio prompts, such as sound effects or speech, guiding the end user's focus. A distraction template can involve strategies to manage potential distractions within a virtual experience. A designer or developer can, as examples, use techniques such as adjusting the opacity of non-essential elements, minimizing background noise, or employing subtle cues to assist an end user in staying focused on primary content or tasks within a 3D experience. Both attention and distraction templates can assist in designing immersive experiences to ensure that users are guided effectively and can engage in 3D experience content without unnecessary disruptions or information overload. An ML model can be trained to generate a recommend attention or distraction template by training the model on training data that includes previously designed attention or distraction templates along with the elements the attention or distraction templates were designed for.

As yet other examples, AI-based interaction recommendations can be used to generate gesture-based, gaze-based, or biometric-input-based interactions having wide accessibility. Interactions having wide accessibility are those that are designed to be inclusive and usable by a diverse range of users having a diverse range of characteristics and/or abilities. Designing for wide accessibility includes considering the interactions of users with different abilities, preferences, and levels of familiarity with technology, and can involve creating interaction patterns that are intuitive, easy to learn, and can accommodate various input methods or devices. Designing for wide accessibility can also consider factors such as providing alternatives for users with disabilities, ensuring readability, and offering seamless experiences for individuals with different cultures backgrounds or different physiological characteristics. Accordingly, designing for wide accessibility can mean designing interactions that are not only technically inclusive, but are also culturally sensitive, ensuring that users from various backgrounds can comfortably and effectively engage with the virtual environment. An ML model can, as examples, tailor interactions of a 3D experience to the individual physiology and culture of an end user, or more effectively permit an experience designer to design interactions accessible to the widest variety of users.

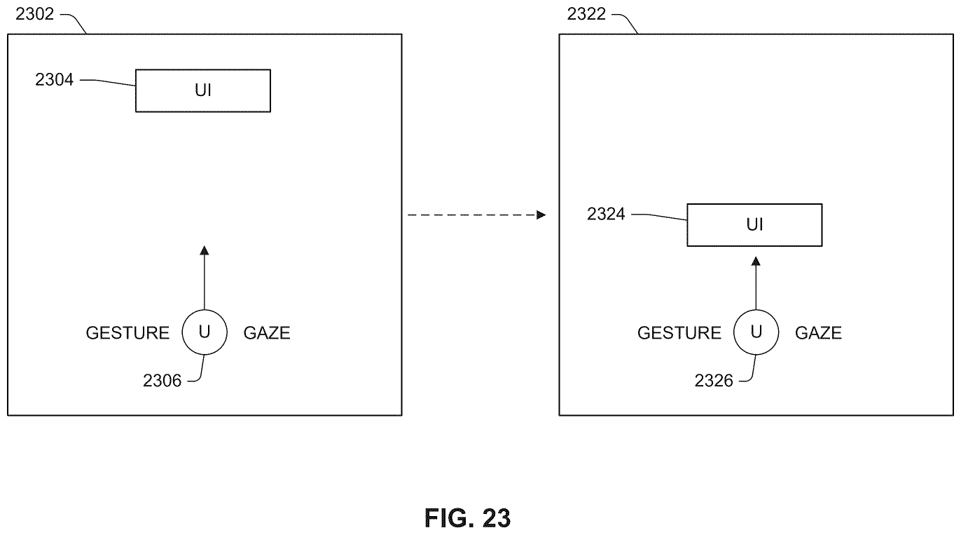

FIG. 23 illustrates an example gesture-based, gaze-based, or biometric-input-based interaction having wide accessibility generated based on AI-based interaction recommendations. In the illustrated example, a user 2306 in a 3D experience 2302 has an interaction with a UI 2304 of the 3D experience 2302 that is based on some combination of gesture and gaze, for example, the user 2302 looking at the UI 2304 and interacting with the UI 2304 by engaging a control of the UI 2304 using a gesture such as a button press motion. An AI-based recommendation presented to a designer of the 3D experience 2302 suggests that the interaction be adjusted for accessibility purposes by bringing the UI 2304 into closer proximity with the user 2306 for ease of interactability, resulting in modified 3D experience 2322 having corresponding user 2326 and UI 2324. The AI-based interaction modification suggestion in the example of FIG. 23 can be made in an automated or semi-automated manner, as described above.

One or more ML models can also be trained to provide inferences that promote AI-based design collaboration and/or AI-based spatial object creation. As an example, AI-based design collaboration can be furthered with AI tools that perform text to development/coding or speech to text to development/coding. As another example, AI-based spatial object creation can be furthered with AI tools that perform text to spatial object creation or speech to text to spatial object creation. As an example of text to development/coding, a natural language prompt is processed by a large language model (LLM) to generate procedures or computer code in a computer language, such as a compilable language, a scripting language, a markup language, or a style sheet language. The procedures or computer code can subsequently be used to generate aspects of the 3D experience or to control the 3D experience in some way. The designer or developer is thereby aided in the design or development process by automating aspects of the code development process. As an example of text to spatial object creation, a natural language prompt is processed by an LLM to generate 3D model geometry and/or textures and/or object animations to create 3D objects renderable within a 3D experience. The designer or developer is thereby aided in the design or development process by automating aspects of the spatial object creation process. In either of these cases, text of the natural language prompt can be generated from speech-based input from the designer or developer, which can be processed, for example, using an ML model to convert the audio speech input to textual data to be provided to the LLM as the text prompt.

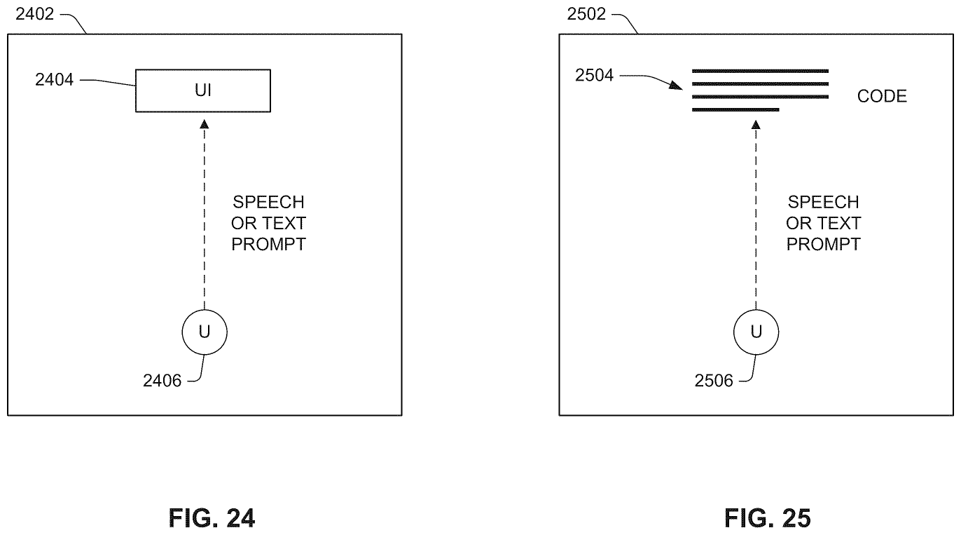

FIGS. 24 and 25 illustrate examples of AI-based design or development collaboration. In the illustrated example of FIG. 24, a user 2406 in a 3D experience 2402 provides a speech prompt, which is converted to a text prompt by a speech-to-text converter, such as an ML model, or provides a text prompt directly. The generated or provided text prompt is then processed, for example using one or more LLMs, to generate a new or modified UI in the 3D experience 2402. In the illustrated example of FIG. 25, a user 2506 in a 3D experience 2502 provides a speech prompt, which is converted to a text prompt by a speech-to-text converter, such as an ML model, or provides a text prompt directly. The generated or provided text prompt is then processed, for example using one or more LLMs, to generate coding 2504 that can be used to control or direct the design or functioning of the 3D experience 2502. The AI-based design or development collaboration in the examples of FIGS. 24 and 25 can be made in an automated or semi-automated manner, as described above.

### Recording of Spatial Interface Designer Inputs to Create Custom User-Interface Interactions for End-User Use

Creation of 3D spatial experiences and interactions with real-world objects, digital objects, users, or digital user avatars, in VR, AR, or XR, can involve a designer creating custom interactions. Such interactions can involve, as examples, any one of, or combinations of, gestures, gaze patterns, and biometrics. User inputs used to complete an interaction and thereby engage with one or more elements of a 3D experience can be recorded as user input data and stored in a data store. Inputs for an interaction can be recorded for a plurality of users, or multiple interactions by a single user can be recorded, and the recorded plurality of user input data recordings can similarly be stored. AI can be employed to aggregate and average the plurality of user input data recordings for a given interaction to determine a baseline of human input for the interaction. Depending on the data aggregated, this baseline can be unique to a particular user or can be general to a group of users.

As one example, a plurality of users can be recorded each performing the same gesture interaction, or a single user can be recorded repeatedly performing the same gesture interaction, to design a custom gesture interaction for interacting with applications, digital objects, objects, users, or digital users. As another example, a plurality of users can be recorded each performing the same gaze-based interaction, or a single user can be recorded repeatedly performing the same gaze-based interaction, to design a custom gaze-based interaction for interacting with applications, digital objects, users or digital users. As another example, a plurality of users can be recorded each performing the same biometric-based interaction, or a single user can be recorded repeatedly performing the same biometric-based interaction, to design a custom biometric-based interaction for interacting with applications, objects, digital objects, users or digital users. In other examples, more than one of gestures, gaze, and biometrics are involved in the recorded interaction.

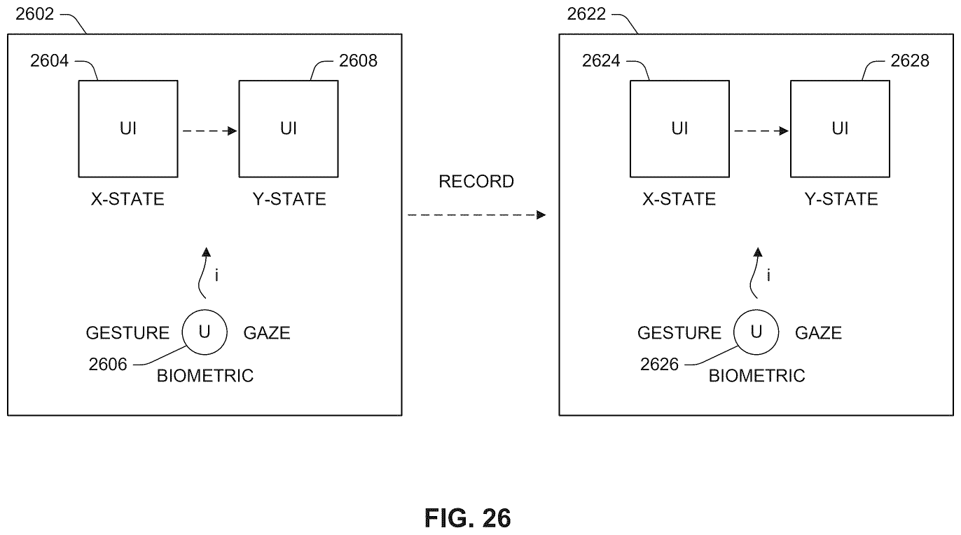

FIG. 26 illustrates an example of recording of gesture-based, gaze-based, and/or biometric-based interactions to design custom interactions with applications, digital or real-world objects, users, or digital user avatars. In the illustrated example, a user 2606 of a 3D experience 2602 provides a gesture-based, gaze-based, and/or biometric-based interaction i to a UI 2604 in an X-state, thereby placing the UI 2604 in a Y-state as UI 2608. The interaction i is recorded and stored. Upon retrieval, the interaction can be played back to recreate the transition of the UI from the X-state to the Y-state, as shown in FIG. 26 by recreated 3D experience 2622, X-state UI 2624, Y-state UI 2628, and user 2626.

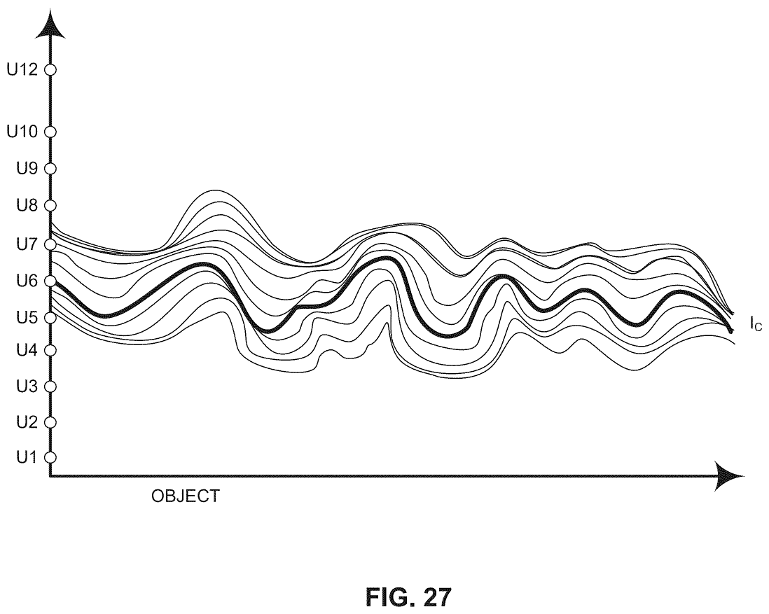

The graph of FIG. 27 illustrates an example of AI employed to aggregate and average a plurality of user input data recordings for a given interaction to determine a baseline of human input for the interaction. The baseline can be customized to a particular user, or to a group of users, for a particular interaction. In FIG. 27, each of the plurality of individual user input data recordings for the given interaction is represented by a thinner solid line, and an average interaction determined therefrom is denoted by thicker line I_{C}. The average interaction can be determined, for example, using an ML model trained to perform interaction averaging. Although for purposes of illustration the graph of FIG. 27 is represented as a two-dimensional graph, the graph may in some examples be multidimensional, with each dimension representing an aspect of user inputs such as gesture inputs, gaze inputs, or biometric inputs. The derived baseline I_{C} can subsequently be used to compare new user inputs to the derived baseline I_{C} to determine whether each new user input qualifies as the specified interaction. A new user input can, for example, be deemed to qualify as the specified interaction if it falls within some tolerance of the derived baseline I_{C}.

In some examples, AI-based averaging and aggregation of designer-recorded interaction inputs can be used to match machine-learned user averages.

### Multiuser Design Collaboration

Multiple designers and/or developers can communicate with each other to collaborate in the design and development of 3D experiences. The ability to communicate using the same UI, from multiple devices, from similar or multiple perspectives can afford designers in a design team a collaborative approach to spatial interaction design. Picture-in-picture functionality, perspective switching, and/or spatial screen sharing can be used to aid multidevice collaboration. In some examples, users can use a multiuser cloud-based spatial design platform to collaborate with each other on spatial design tasks. The spatial design platform can be configured to enable logins of different designers to the spatial design platform and can be configured to control permissions of the different designers to enable each designer to modify, or disable each designer from modifying, properties of elements of the 3D experience. The enabling or disabling can be on a global, by-element, or by-property basis. The property modification can be manual, automated, or semi-automated, for example, by recommendation from an ML model, as described above.

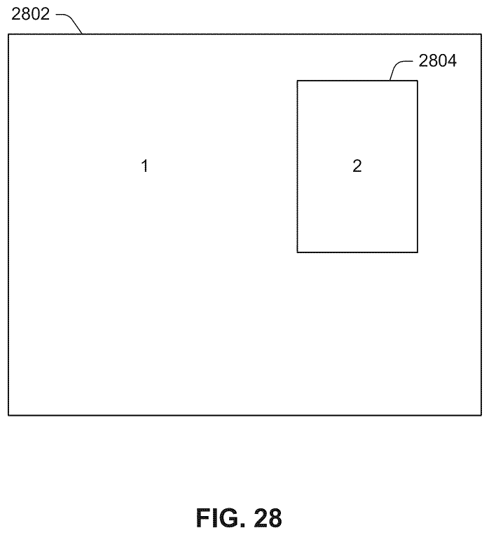

FIG. 28 illustrates an example picture-in-picture functionality as may be used for multiuser picture-in-picture online collaboration within a VR design, development, and prototyping/testing software environment. A first user may see a first view 2802 of the first user and also, contemporaneously, a second view 2804 of a second user rendered within the first view 2802 in picture-in-picture fashion. The design, development, and prototyping/testing environment can be used to aid deployment across design, development and user testing and playtesting phases. The environment can render multiple screen experiences can be rendered regardless of stakeholder.

Systems, methods, and computer-readable media as described herein can provide for multi-platform prototyping, deployment, and testing. The multiple platforms for which prototyping, deployment, and testing may be desired can include, as examples, online platforms, VR platforms, desktop or laptop 2D screen platforms, and mobile device 2D screen platforms. The design, development, and prototyping/testing environment can render views of a spatial experience in multiple different platform versions simultaneously, or provide A/B view switchability between different platform renderings. The design, development, and prototyping/testing environment can permit one or a plurality of design team members to view one or more other team members' perspectives in real time with live audio interactions and screen take-over functionality to aid the collaborative design process.

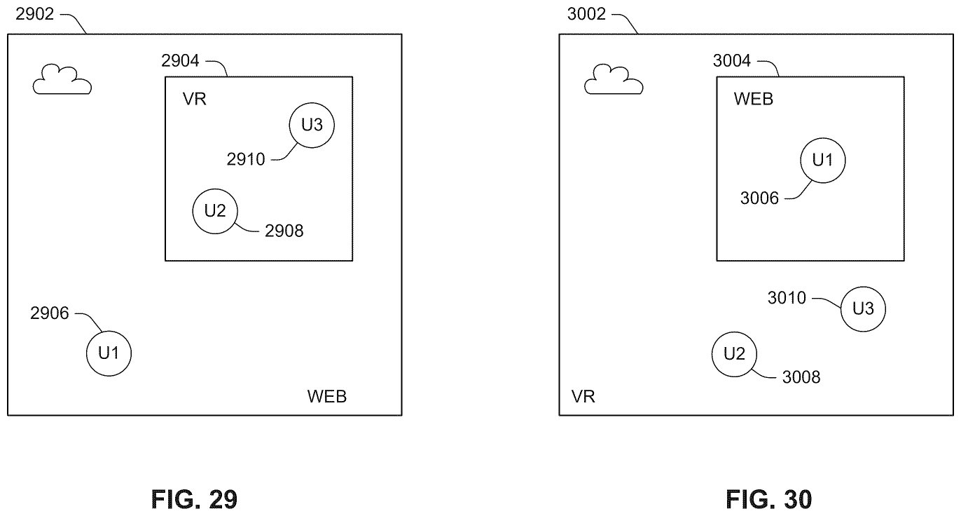

FIGS. 29 and 30 illustrate examples of a multiuser cloud-based spatial design platform that designers can use to collaborate with each other on spatial design tasks. In the example of FIG. 29, a first user 2906 collaboratively engages with spatial design tasks for a 3D experience using a cloud-based design platform 2902 and uses a web platform view to perceive the 3D experience. Contemporaneously, the first user 2906 may perceive one or both respective VR platform views of second and third users 2908, 2910 in a picture-in-picture 2904. Meanwhile, as shown in FIG. 30, the second and third users 3008, 3010 collaboratively engage with spatial design tasks for the 3D experience using the cloud-based design platform 3002, each perceiving the 3D experience with a respective VR platform view. Each of the second and third users 3008, 3010 may also contemporaneously perceive the web platform view 3004 of the first user 3006 in a picture-in-picture 3004 within their own respective VR platform view.

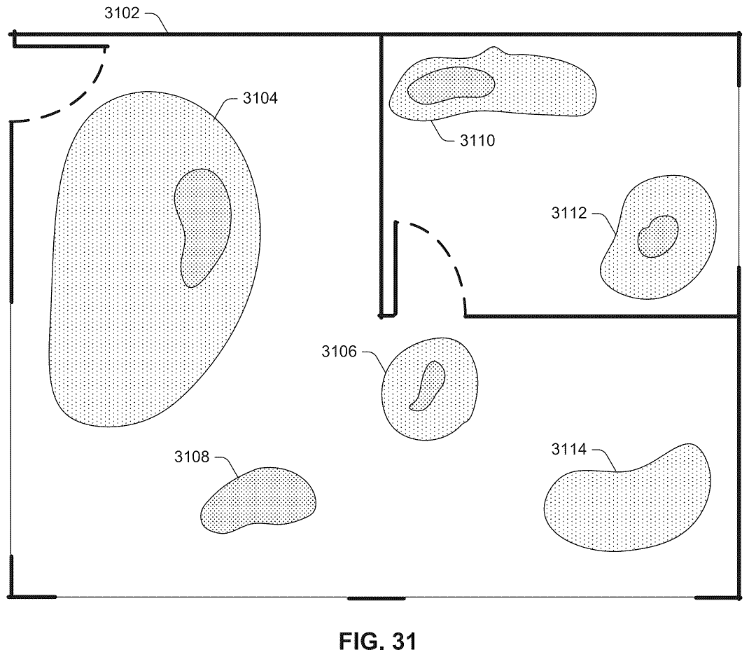

A multiuser cloud-based spatial design platform may also be configured to permit multiuser perspective taking for experiential feedback. FIG. 31 illustrates an example multiuser perspective of a 3D experience environment 3102 illustrated as a plan view of rooms of a building with perception and/or interaction zones of users 3104, 3106, 3108, 3110, 3112, 3114 also shown. The perception and/or interaction zones 3104, 3106, 3108, 3110, 3112, 3114 provide visualizations of user-individualized or user-aggregated attention or attempted interaction data, and thus offer designers and developers insights as to user focus within the 3D experience environment 3102 that in turn can be used to modify or improve the design of the 3D experience environment 3102 or elements thereof. In some examples, the spatial design platform can also permit for quick assumption of different perspectives of alternative AI recommendations and/or alternative AI-recommended templates.

In some examples, the spatial design platform can also permit for a multi-display or multi-HMD prototype testing experience. As one example, the spatial design platform can simultaneously or switchably display views that replicate or simulate the views that would be produced from different display hardware or display technologies. The spatial design platform can thus permit a designer to compare suitability of views of scenes or elements, showing, for example, with reference to FIG. 10, an element as it would be viewed through different HMDs, taking into account dynamically responsive properties of elements that may change responsive to display settings, display hardware specifications, design rules, and/or AI recommendations. As another example, the spatial design platform can simultaneously or switchably replicate or simulate interactivity that would be had with different interaction hardware or interaction technologies, taking into account dynamically responsive interaction templates that may change responsive to input hardware specifications, interactivity rules, and/or AI recommendations. As yet another example, the spatial design platform can simultaneously do either or both of view comparison and/or interaction comparison, along with providing AI-based feedback that can be automatically or semi-automatically implemented to institute design modifications in ways like those described above.

The above-described systems, such as system 200 of FIG. 2, can operate using software that encodes instructions on one or more non-transitory computer-readable media. The above-described methods, such as method 300 of FIG. 3, can be implemented as software instructions on one or more non-transitory computer-readable media. The computer-readable media can be read by one or more general-purpose or special-purposes processors. The software can include, as examples, instructions stored on one or more non-transitory computer-readable media of one or more servers or cloud devices hosting the spatial design platform 214 of FIG. 2 to perform the spatial design functions described above.

Modifications are possible in the described examples, and other examples are possible within the scope of the claims.

What is claimed is:

1. A system for collaborative three-dimensional (3D) experience design, comprising:
a multiuser cloud-based spatial design platform configured to enable logins of first and second computing devices and to display first and second views of a spatial environment of a 3D experience including at least one visual element of the 3D experience to respective first and second displays of the first and second computing devices contemporaneously, wherein:
the spatial design platform is configured to enable the first display displaying the first view to simultaneously or switchably display the second view of the spatial environment, and
the spatial design platform is configured to enable the second display displaying the second view to simultaneously or switchably display the first view of the spatial environment; and
a machine learning (ML) model trained using 3D experience visual element property data, wherein:
the spatial design platform is configured to enable each of the first and second computing devices to modify at least one property of the at least one visual element of the 3D experience based on a visual element property modification recommendation derived from an inference of the ML model.

2. The system of claim 1, wherein the first view is a stereoscopic head-mounted display (HMD) view and the second view is a two-dimensional (2D) display view and the second view is a mobile device view.

3. The system of claim 1, wherein the spatial design platform is further configured to perform co-location and alignment operations between digital content in relation to real world surfaces based on one or more of imported and comparative data including digital twins of real world locations and surfaces or machine learning and vision operations based on user position, head direction, and eye position.

4. The system of claim 3, wherein the spatial design platform is further configured to:
prioritize the operations based on availability of computer resources;
provide content storage of positions and alignments of inputs to produce an evolving model of physical locations across time and space; and
perform iterative optimization of 3D data to enable efficient interaction between a head-mounted display and digitally created and positionally accurate content across time.

5. The system of claim 1, wherein the first view is a first stereoscopic head-mounted display (HMD) view of a first HMD and the second view is a second stereoscopic HMD view of a second HMD having at least one display setting different from the first HMD.

6. The system of claim 5, wherein the at least one display setting is a field of view setting.

7. The system of claim 1, wherein the first view is a first stereoscopic head-mounted display (HMD) view of a first HMD and the second view is a second stereoscopic HMD view of a second HMD having at least one display hardware specification different from the first HMD.

8. The system of claim 7, wherein the at least one display hardware specification is a display aspect ratio specification or a display resolution specification.

9. The system of claim 1, wherein the spatial design platform is configured to anchor the visual element to one or more of a position associated with a set of coordinates in the spatial environment or a window of time.

10. A system for three-dimensional (3D) experience design, comprising:
a spatial design platform configured to:
display a first view of a spatial environment of a 3D experience including at least one visual element of the 3D experience to a display;
automatically modify at least one property of the at least one visual element of the 3D experience from a first property state to a second property state different from the first property state based on a proximity value indicative of a distance between the at least one visual element and a second element of the 3D experience, wherein the first view replicates or simulates display of the spatial environment with the at least one property of the at least one visual element in the first property state; and
enable the display displaying the first view to simultaneously or switchably display a second view of the spatial environment, wherein the second view replicates or simulates display of the spatial environment with the at least one property of the at least one visual element in the second property state.

11. The system of claim 10, wherein the second element is an avatar of a user of the 3D experience.

12. The system of claim 10, wherein the second element is an object of the 3D experience different from the at least one visual element.

13. The system of claim 10, wherein the automatically modified at least one property is a size property.

14. The system of claim 10, wherein the automatically modified at least one property is an element position relative to another element of the 3D experience.

15. A system for three-dimensional (3D) experience design, comprising:
a spatial design platform configured to:
display a first view of a spatial environment of a 3D experience including at least one visual element of the 3D experience to a display, wherein the first view replicates or simulates display of the spatial environment by first display hardware or a first display technology;
enable the display displaying the first view to simultaneously or switchably display a second view of the spatial environment, wherein the second view replicates or simulates display of the spatial environment by second display hardware different from the first display hardware or a second display technology different from the first display technology,
wherein at least one property of the at least one visual element of the 3D experience is automatically modified in the second view based on a display setting or display hardware specification of the second display hardware or second display technology.

16. The system of claim 15, wherein the at least one property is automatically modified based on a display setting, and the display setting is a field of view setting.

17. The system of claim 15, wherein the at least one property is automatically modified based on a display hardware specification, and the display hardware specification is a display aspect ratio specification.

18. The system of claim 15, wherein the at least one property is automatically modified based on a display hardware specification, and the display hardware specification is a display resolution specification.

19. A system for three-dimensional (3D) experience design, comprising:
a machine learning (ML) model trained using 3D experience visual element property data; and
a spatial design platform configured to:
display a first view of a spatial environment of a 3D experience including at least one visual element of the 3D experience to a display, wherein the first view replicates or simulates display of the spatial environment by first display hardware or a first display technology;
enable the display displaying the first view to simultaneously or switchably display a second view of the spatial environment, wherein the second view replicates or simulates display of the spatial environment by second display hardware different from the first display hardware or a second display technology different from the first display technology,
wherein at least one property of the at least one visual element of the 3D experience is automatically modified in the second view based on a visual element property modification recommendation derived from an inference of the ML model.

20. The system of claim 19, wherein the automatically modified at least one property is an element position relative to another element of the 3D experience.
